(19) United States
(12) Patent Application Publication
(10) Pub. No.: US 2026/0160897 A1
(43) Pub. Date: Jun. 11, 2026

(54) GLOBAL NAVIGATION SATELLITE SYSTEM JAMMING AND SPOOFING DETECTION APPARATUS AND METHOD

(71) Applicant: Shift5, Inc., Rosslyn, VA (US)

(72) Inventors: Brandon G. Overall, Hanover, MD (US); Richard Michael Battista, Ashburn, VA (US); David Patrick Twitchell, Haddonfield, NJ (US); Ronak B. Shah, Bethesda, MD (US)

(21) Appl. No.: 19/181,658

(22) Filed: Apr. 17, 2025

Related U.S. Application Data
(60) Provisional application No. 63/636,131, filed on Apr. 19, 2024.

(51) Int. Cl. G01S 19/21; G01S 19/37

(52) U.S. Cl. CPC G01S 19/215; G01S 19/37

(57) ABSTRACT

An apparatus for detecting global navigation satellite system (GNSS) spoofing and jamming in a moving asset includes an intake module configured to receive position data relating to the moving asset from multiple position data sources and to generate formatted position data based on the received position data. The apparatus further includes a spoofing and jamming detection module coupled to the intake module. The spoofing and jamming detection module is configured: to receive the formatted position data, the formatted position data including GNSS information relating to the moving asset from a first position data source of the multiple position data sources; to determine whether a received GNSS signal is degraded based on the GNSS information received from the first position data source; and to generate a GNSS jamming alert and/or a GNSS spoofing alert when a degradation of the GNSS signal exceeds a first prescribed threshold.

### REFERENCE TO PRIORITY APPLICATION

The present application claims priority from U.S. Provisional Application No. 63/636,131, filed Apr. 19, 2024, the disclosure of which is incorporated herein by reference in its entirety.

### FIELD

The present disclosure relates generally to data collection and analysis, and more particularly relates to detecting instances of global navigation satellite system (GNSS) spoofing and/or jamming.

### BACKGROUND

The GNSS generally refers to any satellite constellation that provides positioning, navigation and timing (PNT) services on a global or regional basis. Although the term “GNSS” is often used interchangeably with the term “global positioning system/satellite (GPS),” GPS generally refers to a specific GNSS constellation owned and operated by the U.S. government. GNSS plays a critical role in various applications, particularly within the aviation, marine and automobile industry. From precise navigation and landing procedures to air traffic management and emergency response, reliable GPS signals are essential for ensuring the safety and efficiency of air, land and marine travel. However, the increasing accessibility and affordability of GPS jamming and spoofing technologies pose a significant threat to GNSS-dependent systems.

GNSS/GPS jamming generally involves disrupting or overwhelming the weak GPS signals received by a vehicle's or aircraft's navigation system using targeted radio frequency signals. From a pilot's perspective, this can render the GPS on board the aircraft inoperable, potentially leading to a loss of situational awareness; that is, pilots may be unable to determine their location, altitude, or heading, thereby increasing the risk of disorientation and mid-air collisions. Since many modern aircraft rely on GPS data for autopilot functionality, GPS jamming can lead to erratic maneuvers or complete loss of autopilot control.

GNSS/GPS jamming can also cause a disruption of air traffic control (ATC) systems. Inaccurate or missing GPS data can compromise an ATC system's ability to track and manage aircraft movement, potentially causing delays and safety hazards.

Similar to GNSS/GPS jamming, GNSS/GPS spoofing involves manipulating GPS signals to provide false location data to a GPS receiver. This can be used by a malicious actor to spoof an aircraft's location to mislead ATC systems, potentially causing airspace violations or disrupting air traffic patterns. Spoofing may also be exploited by cyberattackers to target critical infrastructure that relies on GPS timing signals, such as financial systems or communication networks.

The ease with which these technologies can be acquired and deployed necessitates the development of reliable methods for detecting and mitigating GPS jamming and spoofing. This is especially crucial for airborne assets, where the consequences of disrupted or manipulated GPS data can be catastrophic.

While some existing solutions may attempt to address GPS jamming and spoofing, they often have limitations. These limitations may include, for example, limited detection range, susceptibility to advanced spoofing techniques, and high cost and complexity.

Therefore, there exists a need for a novel and improved approach to detect GPS jamming and spoofing, particularly for applications in the aviation, marine or automobile industry, among other uses.

### SUMMARY

The present invention, as manifested in one or more embodiments thereof, is directed to apparatus, systems and/or methods for analyzing communication bus (e.g., serial bus) data to detect instances of GNSS spoofing and jamming. In one or more embodiments, aspects of the inventive concept may be incorporated into a “GPS Integrity Module,” a platform-independent solution applicable for military, aviation, rail, maritime and space industries. With real-time access and analysis of onboard data, the GPS Integrity Module assesses changes in navigational position through multifaceted anomaly detection methods, alerting operators to GPS spoofing and/or jamming attacks as they happen. The GPS Integrity Module according to embodiments of the inventive concept beneficially enables operators to make smarter, faster and safer decisions based on automated detection capabilities to thereby mitigate risks involving the manipulation of GNSS/GPS signals to help ensure the accuracy and reliability of airborne, ground and space navigation.

While some existing approaches may attempt to address GPS jamming and spoofing, they often have limitations. These limitations may include, for example, limited detection range (existing detection systems may not be able to identify jamming or spoofing attempts from a significant distance), susceptibility to advanced spoofing techniques (sophisticated spoofing methods can bypass traditional detection algorithms), and high cost and complexity (implementing robust anti-jamming and anti-spoofing systems can be expensive and require significant technical expertise).

In accordance with one or more embodiments of the present inventive concept, an apparatus, system and/or method for detecting GNSS jamming and spoofing attacks on assets (e.g., aircraft, watercraft, buses, automobiles, trains, etc.), which may be referred to herein as moving or movable assets, are provided.

An apparatus, system and/or method according to one or more embodiments of the present disclosure comprises a stateful module configured to analyze data signals from multiple onboard ground or airborne (e.g., avionics) systems. By way of example only, the system according to some embodiments may comprise a stateful module configured to analyze data signals from two or more long-range navigation (LRN) line replaceable units (LRUs) communicating via ARINC-429 protocol, an inertial reference unit (IRU) communicating via Avionics Standard Communication Bus (ASCB), etc. The system according to embodiments of the invention may be configured to combine serial bus information with raw satellite data by collecting radio frequency (RF) signals. In this manner, embodiments of the inventive concept leverage complementary data streams from independent systems to enhance detection reliability.

In accordance with an embodiment of the inventive concept, an apparatus for detecting GNSS spoofing and jamming in a moving asset includes an intake module configured to receive position data relating to the moving asset from multiple position data sources and to generate formatted position data based on the received position data. The apparatus further includes a spoofing and jamming detection module coupled to the intake module. The spoofing and jamming detection module is configured: to receive the formatted position data, the formatted position data including GNSS information relating to the moving asset from a first position data source of the multiple position data sources; to determine whether a received GNSS signal is degraded based on the GNSS information received from the first position data source; and to generate a GNSS jamming alert and/or a GNSS spoofing alert when a degradation of the GNSS signal exceeds a first prescribed threshold.

In accordance with another embodiment of the inventive concept, an apparatus for detecting GNSS spoofing and jamming in a moving asset includes an intake module configured to receive position data relating to the moving asset from a received RF GNSS signal and to format an analog waveform from the received RF GNSS signal into a corresponding digital signal. The apparatus further includes an RF signal processing unit operatively coupled to the intake module and a spoofing and jamming detection module operatively coupled to the RF signal processing unit. The RF signal processing unit is configured to receive the digital signal provided by the intake module and to extract metadata from the digital signal. The metadata extracted by the RF signal processing unit comprises information used to determine a state of a GPS RF state processing unit in the spoofing and jamming detection module. The GPS RF state processing unit is configured to generate an output signal indicative of the presence of a jamming and/or spoofing event, based at least in part on the metadata extracted by the RF signal processing unit.

Aspects of the present inventive concept can provide substantial beneficial technical effects. By way of example only and without limitation, techniques according to embodiments of the present disclosure may provide one or more of the following advantages, among other benefits:
leverages complementary data streams from independent system, such as IRUs, to enhance detection reliability;
provides drift compensation by dynamically calculating and applying a correction factor (i.e., “shift” or offset) to IRU data to improve the accuracy of spoofing detection;
provides gradual spoofing detection by tracking IRU/GPS divergence over time with drift compensation;
eliminates common sources of false-positives by tracking a moving asset's state and movement status to rule out benign interference sources;
does not require expensive replacement of onboard GNSS receivers with more capable ones since it utilizes existing data streams.

These and other features and advantages of the present inventive concept will become apparent from the following detailed description of illustrative embodiments thereof, which is to be read in connection with the accompanying drawings.

### BRIEF DESCRIPTION OF THE DRAWINGS

The accompanying drawings, which are included to provide a further understanding of the invention and are incorporated in and constitute a part of this application, are presented by way of example only and without limitation, wherein like reference numerals (when used) indicate corresponding elements throughout the several views, and wherein:

FIG. 1 is a schematic block diagram depicting at least a portion of an exemplary cloud-based system configured for detecting GPS jamming and/or spoofing, according to one or more embodiments of the inventive concept;

FIG. 2 is a schematic block diagram depicting at least a portion of an exemplary hardwired system for detecting GPS jamming and/or spoofing, according to one or more embodiments of the present disclosure;

FIG. 3 is a flow diagram depicting at least a portion of an exemplary method for detecting the potential presence of GPS jamming and generating a GPS jamming alert in response thereto, according to one or more embodiments of the present disclosure;

FIG. 4 depicts a flow diagram describing an exemplary method for detecting the potential presence of GPS spoofing and generating a GPS spoofing alert in response thereto, according to one or more embodiments of the present disclosure;

FIG. 5 depicts a flow diagram describing an exemplary method for calculating whether there is a GPS spoofing attempt based on multiple data sources, according to one or more embodiments of the present disclosure;

FIG. 6 is a flow diagram depicting an exemplary method for determining whether there is a GPS timing anomaly and generating an alert in response thereto, according to one or more embodiments of the present disclosure;

FIG. 7 is a block diagram depicting an implementation of a GPS RF signal processing unit of the GPS spoofing and jamming detection system configured for RF-only GPS spoofing detection, according to one or more embodiments of the present disclosure;

FIGS. 8A and 8B are block diagrams depicting at least a portion of a correlation unit that may be employed in each of the processing pipelines in the illustrative GPS RF signal processing unit shown in FIG. 7, according to one or more embodiments of the present disclosure;

FIGS. 9A-9C is a flow diagram depicting at least a portion of an example method which may be performed by a GPS RF state processing unit, according to one or more embodiments of the present disclosure; and

FIG. 10 is a flow diagram depicting at least a portion of an example combined GPS alerts method which may be performed by a GPS RF state processing unit, according to one or more embodiments of the present disclosure.

It is to be appreciated that elements in the figures may be illustrated for simplicity and clarity. Common but well-understood elements that may be useful or necessary in a commercially feasible embodiment are not necessarily shown in order to facilitate a less hindered view of the illustrated embodiments.

### DETAILED DESCRIPTION

Principles of the present invention, as manifested in one or more embodiments thereof, may be described herein in the context of apparatus, systems and methods for detecting GPS jamming and spoofing attacks on ground and airborne assets for military, aviation, rail, maritime and space industries. It is to be appreciated, however, that the invention is not limited to the specific apparatus, systems and/or methods illustratively shown and described herein, nor are aspects of the inventive concept limited to the specific applications, systems, buses and/or communications protocols with which embodiments of the invention may be utilized. Rather, it will become apparent to those skilled in the art given the teachings herein that numerous modifications to the embodiments shown and described herein are contemplated and are within the scope of the present inventive concept. That is, no limitations with respect to the embodiments shown and described herein are intended or should be inferred.

As previously stated, global navigation satellite system (GNSS) refers to any satellite constellation that provides positioning, navigation and timing (PNT) services on a global or regional basis. The term “global positioning system or satellite (GPS) generally refers to a specific GNSS constellation owned and operated by the U.S. government. These two terms, “GNSS” and “GPS,” may be used interchangeably herein, with the understanding that embodiments of the invention are not limited to using only specific satellites in the GPS constellation.

Navigation systems have become increasingly reliant on GPS/GNSS signals for ensuring the safety and efficiency of travel, particularly air travel, but also applicable to other travel methods, including marine, automobile, rail, etc. However, the increasing accessibility and affordability of GNSS jamming and spoofing devices pose a significant threat to GNSS-dependent systems. Therefore, assessing the integrity of GNSS signals in a GNSS receiver system has become increasingly important in safety-critical GNSS applications, such as, but not limited to, aviation, marine, or terrestrial navigation.

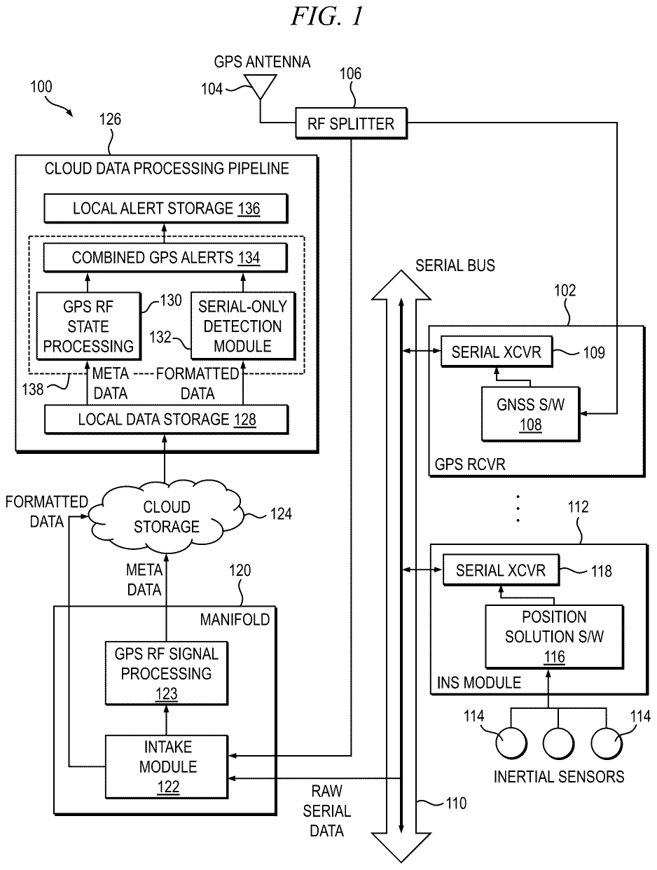

FIG. 1 is a schematic block diagram depicting at least a portion of an exemplary cloud-based system 100 configured for detecting GPS jamming and/or spoofing, according to one or more embodiments of the inventive concept. The GPS jamming and/or spoofing detection system 100 includes a GNSS or GPS receiver 102 operatively connected to a GPS antenna 104. The term “connected” (or “connecting,” or like terms such as “coupled,” “coupling,” “contacted,” etc.), as may be used herein, is intended to comprise direct and indirect physical and/or electrical connection of components or other features, including connection using one or a plurality of intermediate components. As used herein, the term “and/or” includes any and all combinations of one or more of the associated listed items. In some embodiments, a radio frequency (RF) splitter 106 (e.g., power divider, coupler, etc.) may be used to divide the GPS signal received from the GPS antenna 104. An RF splitter is typically a passive device configured to couple a defined amount of electromagnetic power in a transmission line to a port, thereby enabling the received signal to be used by another circuit or component in the system.

The GPS antenna 104 is adapted to receive and, in some cases, amplify the radio signals transmitted on specific frequencies (e.g., signals in the L1 (1575.42 MHz), L2 (1227.6 MHz), or L5 (1176 MHz) frequency bands) by GNSS satellites and convert such signals to an electronic signal used by the GPS receiver 102. GPS signals received from the GPS antenna 104 are provided to a GNSS software (S/W) module 108 which may run GNSS software configured to process GPS signal data from a plurality of GNSS satellites. In some embodiments, the GNSS software module 108 may be configured to receive a timestamp from each of the visible satellites, along with data on where in the sky each satellite is located (among other pieces of data). From this information, the GPS receiver 102 can determine the distance to each satellite in view. In this regard, the GPS receiver 102 may be configured to receive information about where each satellite is at any given moment and, using this information, may determine its own location by measuring the time it takes for a signal to arrive at its location from at least four satellites.

The GPS data generated by the GNSS software module 108 may be provided to a serial transceiver 109 in the GPS receiver 102. The serial transceiver 109 may be configured to convert the GPS data from the GNSS software module 108 into a format suitable for transmission on a serial data bus 110 (e.g., Universal Serial Bus (USB), ARINC-429, RS-232, serial peripheral interface (SPI), peripheral computer interface (PCI), PCI express (PCIe), etc.). By way of example only and without limitation, in the context of commercial aircraft, the serial transceiver 109 may be configured to convert the GPS data from the GNSS software module 108 into ARINC-429 protocol data for transmission on the serial data bus 110, which may be implemented as an ARINC-429 bus, although embodiments are not limited thereto. The ARINC-429 specification defines the standard requirements for the transfer of digital data between avionics systems on commercial aircraft. Such data that may conveyed on the ARINC-429 bus includes, but is not limited to, GNSS latitude/latitude fine, GNSS longitude/longitude fine, GNSS sensor status, GNSS height WGS84 (a global standard for navigation, mapping, and geospatial analysis), HAE (height above ellipsoid, which refers to the vertical location measurement that represents a height above or below the WGS84 ellipsoid), UTC (Coordinated Universal Time) date, and UTC time. ARINC-429 is also known as the Mark 33 Digital Information Transfer System (DITS) specification. Signal levels, timing and protocol characteristics are defined for ease of design implementation and data communications on the Mark 33 DITS bus. ARINC-429's data encoding uses a complementary differential bipolar return-to-zero (BPRZ) transmission waveform, further reducing electromagnetic interference (EMI) emissions from the cable itself.

The serial transceiver 109 may also be configured to receive serial data from the serial data bus 110 and provide such received serial data to the GNSS software module 108 for controlling one or more operations of the GPS receiver 102. In one or more embodiments, the GPS receiver 102 outputs data based on its calculations in formatted messages according to a specific serial protocol specification, and may include data such as, but not limited to, latitude, longitude, altitude, signal strength (including, for example, contrast-to-noise ratio (CNR) and signal-to-noise ratio (SNR)), satellite count, GPS mode, etc.

The GPS jamming and/or spoofing detection system 100 may further include an inertial navigation system (INS) module 112 operatively coupled to one or more inertial sensors 114. The INS module 112 may include a position module 116, which may be configured to execute position solution software, and a serial transceiver 118 coupled to the position module 116. The position module 116 may include a processor configured to receive motion information from the inertial sensors 114 and calculate the position, orientation, and velocity (direction and speed of movement) of a moving object using “dead reckoning,” without the need for external references such as GPS. The inertial sensors 114 may include, for example, motion sensors (e.g., accelerometer), rotation sensors (e.g., gyroscope), barometric altimeter, magnetic sensors (e.g., magnetometers) and/or speed measuring devices, although embodiments are not limited thereto. The INS module 112 may also output its own estimate of the current latitude and longitude by applying dead reckoning velocity changes to an initial position that is configured by an operator or hard-coded into the system based on waypoints and airport codes.

The position, orientation and velocity data calculated by the position module 116 is provided to the serial transceiver 118 for transmission on the serial data bus 110. The serial transceiver 118 may be implemented and configured to operate in a manner consistent with the serial transceiver 109 included in the GPS receiver 102.

Both the GPS receiver 102 and the INS module 112 may provide data relating to the position, orientation and velocity of a moving object (i.e., asset), such as an aircraft. Although only two data sources are shown for providing information relating to the position, orientation and velocity of the moving object, it is to be understood that embodiments are not limited thereto. For example, the system 100 may utilize multiple GPS receivers 102 and/or multiple INS modules 112 as data sources for providing position, orientation and velocity information, not merely for redundancy purposes (although redundancy is a benefit), but for correlating the position, orientation and velocity information among the multiple data sources to ensure the accuracy thereof. In other words, one or more embodiments of the inventive concept may beneficially leverage complementary data streams from multiple independent systems supplying position, orientation and/or velocity data that can be compared against one another to enhance detection reliability and accuracy.

The GPS jamming and/or spoofing detection system 100 further includes a processing module (“manifold”) 120 coupled to the serial data bus 110. The processing module 120 is configured to receive raw serial data relating to the position, orientation, and velocity of a moving object from the serial data bus 110. In one or more embodiments GPS signals received by the GPS antenna 104 may be provided to the processing module 120 through the RF splitter 106, without using the serial bus 110. The processing module 120 may obtain such position, orientation, and velocity information from multiple data sources (e.g., GPS receiver 102 and INS module 112). In one or more embodiments, the processing module 120 is configured to receive position, orientation, and/or velocity information from at least two long-range navigation (LRN) line replaceable units (LRUs), each LRN unit including a GPS receiver consistent with the GPS receiver 102, communicating with one another via ARINC-429 protocol (or other communication protocol), and at least one inertial reference unit (IRU), each IRU including an INS module consistent with the INS module 112, communicating via Avionics Standard Communication Bus (ASCB) protocol (or other communication protocol). ASCB may be used to convey information relating to an aircraft, such as, but not limited to, PPOS (present position) latitude, PPOS longitude, inertial altitude, PPOS latitude flag, longitude valid, system status, and WOW (weight on wheels) status. For other asset types (e.g., watercraft, motor vehicle, etc.), different communication buses and/or communication protocols may be employed.

The processing module 120 may include an intake module 122 coupled to the serial data bus 110 and/or to the RF splitter 106 and is configured to receive the raw serial data from the GPS receiver 102 and INS module 112 and/or the GPS signals from the RF splitter 106, respectively. In one or more embodiments, the intake module 122, which may include a software-defined radio (SDR), may be configured to format the analog waveform from the received RF signal (provided by the RF splitter 106) into a corresponding digital signal, and pass the digital signal to a GPS RF signal processing unit (i.e., GPS RF signal processor) 123 in the processing module 120 so that it can extract the GPS metadata from it.

The formatted data may be stored in a cloud-based network 124 or other storage means providing remote access (wireless or wired) to the stored data. The formatted data generated by the intake module 122 may be provided to the GPS RF signal processing unit 123. The GPS RF signal processing unit 123 may be configured to receive the formatted data from the intake module 122 and to generate metadata, which may be provided to the cloud-based network 124. The metadata may provide information about each of the satellites that are transmitting GPS RF data, especially related to characteristics about the signal itself (e.g., power), and is used to analyze the signal for signs of GPS spoofing/jamming based on the signal rather than computed PNT information from the GPS receiver 102. The metadata generated by the GPS RF signal processing unit 123 may contain all the relevant information subsequently used to determine a state of a GPS RF state processing unit 130 (to be described subsequently), among other information.

In one or more embodiments, the GPS jamming and/or spoofing detection system 100 may include a cloud data processing pipeline 126 configured to receive stored formatted data and/or metadata from the cloud-based network 124 and to perform GPS spoofing and jamming detection using the received data; the data may be stored in a compressed data format. The cloud data processing pipeline 126 may include a local data storage unit 128, for locally storing the formatted data and/or metadata retrieved from the cloud-based network 124; storing “metadata,” in this instance, may refer to taking signal characteristics and storing those characteristics rather than the raw signal itself. Metadata stored locally in the local data storage unit 128 may be provided to a GPS RF state processing unit (i.e., GPS RF state processor) 130, and formatted data stored locally in the local data storage unit 128 may be provided to a serial-only detection module 132. Alerts generated by the GPS RF state processing unit 130 and the serial-only detection module 132 may be provided to a combined GPS alerts unit 134.

The combined GPS alerts unit 134 may be configured to receive an output signal generated by the GPS RF state processing unit 130 and/or the serial-only detection module 132 indicative of a potential GPS spoofing and/or jamming condition, and to generate an alert that rules out false positives. For example, in one or more embodiments, the combined GPS alerts unit 134 may be configured to execute one or more algorithms designed to isolate and remove conditions that may lead to a false positive event (e.g., noise filters, asset movement verification, valid GPS navigation mode validation, etc.). The alerts provided by the combined GPS alerts unit 134 may be stored in a local alert storage unit 136.

The GPS RF state processing unit 130, the serial-only detection module 132 and the combined GPS alerts unit 134 may be part of a GPS spoofing and jamming detection module 138 in the cloud data processing pipeline 126. In one or more embodiments, the GPS spoofing and jamming detection module 138 may be implemented, at least in part, using a stateful module (i.e., state machine) or other processor, configured to perform GPS spoofing detection by analyzing LRN data obtained from the local data storage unit 128, which may include position, orientation, and velocity information relating to an asset (e.g., an aircraft), to reconstruct coordinate sets and determine the asset's velocity. Unrealistic velocities (instantaneous or gradual) determined by the GPS spoofing and jamming detection module 138 will trigger the GPS spoofing and jamming detection module 138 to store an alert in the local alert storage unit 136 indicative of suspected GPS spoofing. This helps distinguish GPS interference sources that can occur while the aircraft is on the ground (i.e., not moving), such as when inside a hangar or surrounded by large buildings, thereby reducing the likelihood of generating false alerts.

In some embodiments, the GPS spoofing and jamming detection module 138 may first perform a set of steps to rule out possible false positives. Using an aircraft as an example (although not limited to aircraft), the GPS spoofing and jamming detection module 138 may first check to verify that the aircraft is in flight (i.e., off the ground and traveling above a certain velocity). It can also use other aircraft serial bus data to confirm that it is in flight, such as checking the “weight on wheels” value (i.e., whether the wheels are supporting the aircraft's weight on the ground).

The GPS spoofing and jamming detection module 138 may alternatively or additionally determine whether GPS spoofing has occurred by comparing GPS-derived positions provided by the GPS receiver 102 against inertial measurements from the INS module 112. Any significant divergence (i.e., deviation or delta) between the GPS-derived positions determined using the two data sources beyond a calculated drift tolerance may indicate the occurrence of GPS spoofing, thereby triggering the GPS spoofing and jamming detection module 138 to generate and store an alert (e.g., in the local alert storage unit 136). The GPS spoofing and jamming detection module 138 may, in some embodiments, be configured to dynamically calculate and apply a correction factor (“shift”) to the inertial data from the INS module 112. This correction factor accounts for initial position offsets and normal inertial sensor drift, thereby improving the accuracy of the GPS spoofing detection.

With regard to drift tolerance, in one or more embodiments the drift tolerance may be a static value that is configured initially but does not change subsequently. In other embodiments, the drift tolerance may dynamically change based on periodic calculations. In either case, the drift tolerance is a threshold that is used to determine if the GPS position and the IRU position have diverged beyond an acceptable amount.

In one or more embodiments, the GPS and IRU positions may not be compared until after the correction factor (or “shift”) has been applied to the IRU position. This correction factor may be determined, in some embodiments, by calculating an initial difference between GPS and IRU positions and then updating the difference between GPS and IRU positions as the aircraft is in flight. Essentially, every time the two positions are compared, the delta (i.e., difference) between the GPS and IRU positions is stored in memory for some prescribed amount of time as a “shift” value. Old shift values may be “aged off” (e.g., deleted or overwritten) according to some prescribed time limit (e.g., about 3 minutes, although embodiments are not limited thereto). Other criteria may, alternatively or additionally, be used to determine a depth of historical shift values saved by the GPS spoofing and jamming detection module 138, including, for example, memory size.

Before being compared, the IRU position is corrected by determining the oldest valid shift value that has not been aged off and applying this value to the IRU position. This means that any divergence between the GPS and IRU positions after the shift has been applied has occurred within the prescribed time limit (e.g., within the last 3 minutes).

There are some known GPS spoofing mechanisms that employ a subtle spoofing attack, whereby the received GPS data gradually drifts from the actual position, orientation and/or velocity information of the asset over time. Such subtle GPS spoofing attacks may elude traditional GPS spoofing detection techniques which may only detect GPS divergence above a relatively large threshold. By tracking IRU/GPS divergence over time with drift compensation, the GPS jamming and/or spoofing detection system 100 according to embodiments of the inventive concept can detect subtle, gradual spoofing attacks that might otherwise evade traditional GPS spoofing detection methods.

In one or more embodiments, the GPS spoofing and jamming detection module 138 may be configured to detect the occurrence of GPS jamming. In performing GPS jamming detection, the GPS spoofing and jamming detection module 138 may monitor satellite acquisition status from the LRN units, each of which includes a GPS receiver consistent with the GPS receiver 102. Prolonged periods of insufficient satellite lock during flight conditions may suggest potential GPS jamming, or may otherwise be indicative of unreliable received GPS data. This may cause the GPS spoofing and jamming detection module 138 to generate an alert signal indicative of the potential presence of GPS jamming.

As previously described, the GPS jamming and/or spoofing detection system 100 may utilize a cloud-based approach, whereby formatted GPS data and/or metadata can be retrieved from a storage device in the cloud-based network 124 and processed remotely by the cloud data processing pipeline 126. In some scenarios, however, such as when there is a desire to provide a more secure environment (e.g., to prevent malicious attacks, etc.), GPS spoofing and jamming detection may be performed in a closed system, without the use of cloud-based storage or processing.

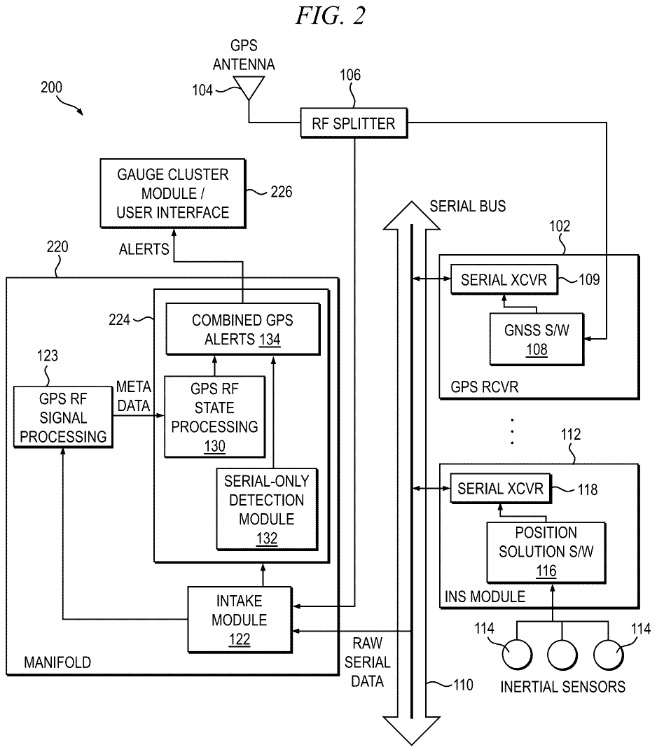

By way of example only and without limitation, FIG. 2 is a schematic block diagram depicting at least a portion of an exemplary hardwired system 200 for detecting GPS jamming and/or spoofing, according to one or more embodiments of the inventive concept. The GPS jamming and/or spoofing detection system 200, like the illustrative system 100 shown in FIG. 1, may utilize a plurality of data sources for obtaining position, orientation and/or velocity information of an asset (e.g., aircraft, motor vehicle, watercraft, etc.). Such data sources may include at least one GPS receiver 102 and at least one INS module 112, although embodiments are not limited to such data sources, nor are embodiments limited to any specific number of a given type of data source. Each of these data sources may communicate with one another and with one or more data processing devices using the serial data bus 110 or other communication bus (e.g., MIL-STD-1553 bus, ARINC-629 bus, Avionics Full-Duplex Switched Ethernet (AFDX) bus, CAN bus, etc.). In other embodiments, modern aircraft may have components that are connected using a standard ethernet network rather than (or in addition to) a serial bus network. Additionally, LRUs may be virtualized or represented (i.e., instantiated) as individual software components on a single piece of hardware (or distributed across multiple hardware components, for example in a distributed computing environment), and may communicate locally using, for example, network, file, or UNIX sockets. As previously stated, like reference numerals indicate corresponding elements in the drawings, and therefore a detailed description of such elements may not be repeated herein for brevity purposes.

The GPS jamming and/or spoofing detection system 200 further comprises a combined GPS spoofing and jamming detection module 224, which may be implemented using a stateful module (i.e., state machine) or other processor and is configured to operate in a manner consistent with the operation of the GPS spoofing and jamming detection module 138 shown in FIG. 1. However, unlike the system 100 wherein GPS spoofing and jamming detection function was performed remotely using data accessed from a cloud-based network 124 (see FIG. 1), the combined GPS spoofing and jamming detection module 224 is incorporated into a processing module (i.e., manifold) 220 in the GPS jamming and/or spoofing detection system 200.

In one or more embodiments, the combined GPS spoofing and jamming detection module 224 includes a GPS RF state processing unit 130, a serial-only detection module 132, and a combined GPS alerts unit 134, each of which may be configured to operate in the manner previously described in conjunction with FIG. 1. Specifically, the serial-only detection module 132 may be configured to obtain formatted data from the intake module 122 and the GPS RF state processing unit 130 may be configured to obtain metadata from the GPS RF signal processing unit 123 and perform local data processing for the detection of GPS spoofing and jamming, without the need for a cloud-based network (e.g., 124 in FIG. 1). The combined GPS alerts unit 134 in the GPS spoofing and jamming detection module 224 is configured to generate alerts indicative of a GPS spoofing and/or GPS jamming condition having a reduced likelihood of false positives.

Similar to the illustrative system 100 shown in FIG. 1, the GPS jamming and/or spoofing detection system 200 may include an RF splitter 106 configured to divide the GPS signal received from the GPS antenna 104 and to distribute the GPS signal to multiple components in the GPS jamming and/or spoofing detection system 200, such as the GPS receiver 102 and the intake module 122. Raw serial data, generated by the one or more GPS receivers 102 and/or the one or more INS modules 112, may be conveyed by the serial bus 110 and provided to the intake module 122. The intake module 122 may be configured to receive raw serial data from the serial bus 110 as well as raw RF data from the RF GPS signal (e.g., captured using a software-defined radio in the intake module 122), and to format the data into forms suitable for use by the combined GPS spoofing and jamming detection module 224 (e.g., the serial-only detection module 132) and the GPS RF signal processing unit 123, respectively.

A primary function of the GPS RF state processing unit 130 in the combined GPS spoofing and jamming detection module 224 is to determine whether the RF GPS signal, captured using the software-defined radio in the intake module 122 (rather than the generic system GPS receiver(s) 102) is being spoofed, based at least in part on the metadata provided by the GPS RF signal processing unit 123. In one or more embodiments, the GPS RF state processing unit 130 may be configured to evaluate possible conditions which may indicate the occurrence of jamming and/or spoofing and set an output of the combined GPS spoofing and jamming detection module 224 to a corresponding state. In addition, the GPS RF state processing unit 130 may, in some embodiments, perform other functions, such as determining other non-spoofing states that can be useful in ascertaining how the GPS receiver 102 is functioning.

It is to be appreciated that the RF GPS signal captured, for example, using the software-defined radio in the intake module 122, in combination with the GPS RF signal processing unit 123 may form a functional “GPS RF receiver.” The GPS RF receiver may not necessarily solve for position, as does the system GPS receiver 102. Rather, the GPS RF receiver is configured to monitor the same input RF GPS signal (i.e., received from the GPS antenna 104 and RF splitter 106) and determine a spoofing and/or jamming state based solely on a physical layer or RF signal layer of the input RF GPS signal. That is, in one or more embodiments, the spoofing and/or jamming state of the system 200 is based on characteristics determined from the metadata being processed, which is obtained from the RF GPS signal, not the generic GPS receiver 102.

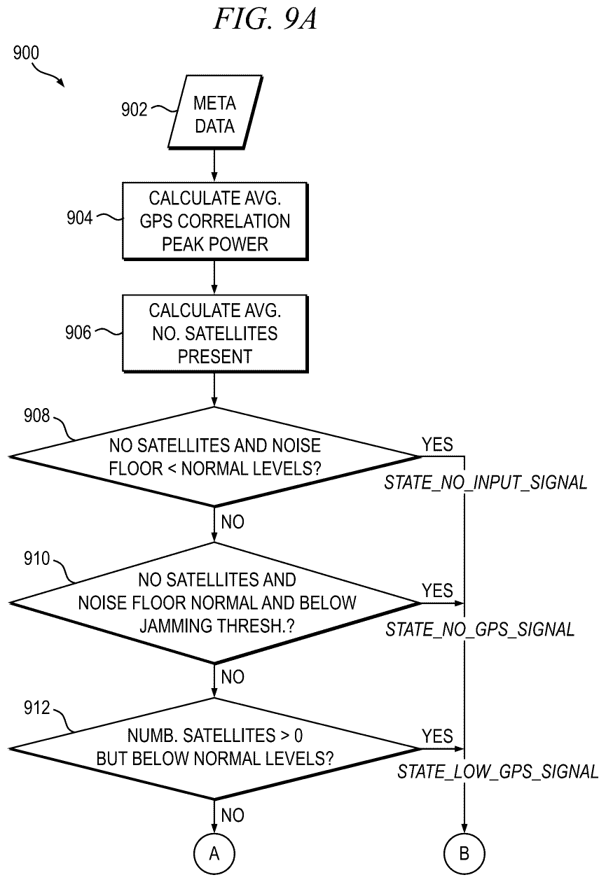

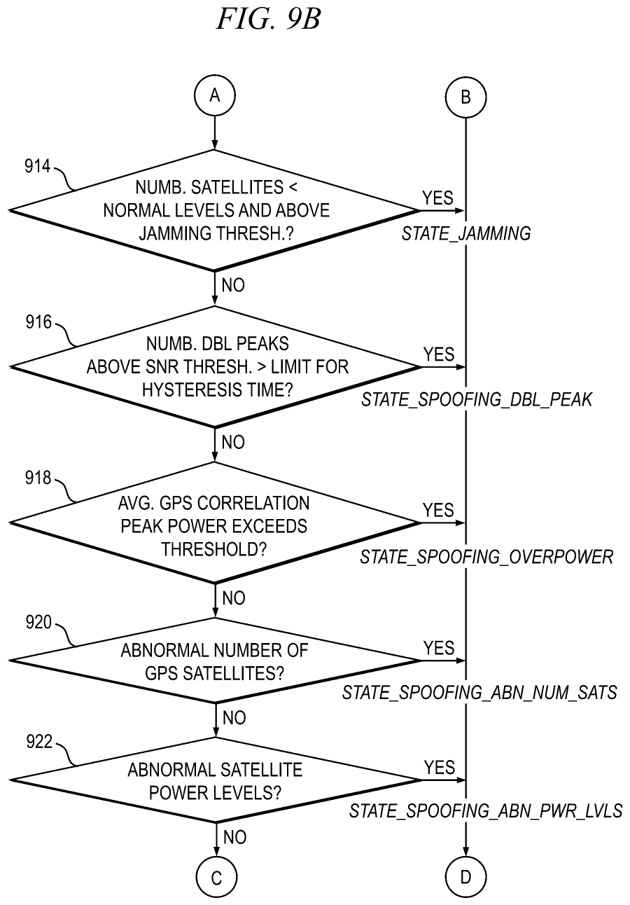

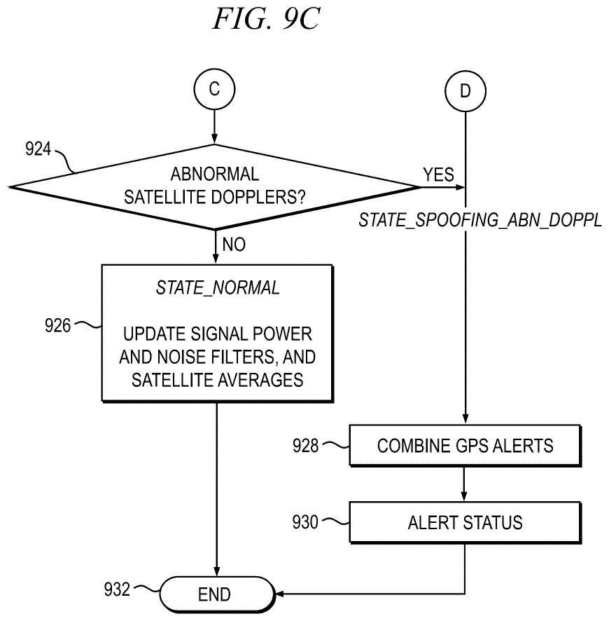

In one or more embodiments, the GPS RF state processing unit 130 may be configured to perform one or more tests that indicate a non-normal state of attributes and/or characteristics of the received RF GPS signal from the GPS antenna 104 and RF splitter 106. As used herein, the term “non-normal” may be defined as any detected anomalies in the RF GPS signal, including, for example, detecting multiple occurrences of the same GPS satellite, an excessive number of GPS satellites, abnormal power levels, etc., some of which are described in connection with the flowgraph shown in FIGS. 9A-9C. If all the tests performed by the GPS RF state processing unit 130 fail, the state of the RF GPS signal is determined to be normal; that is, if any one of the tests performed by the GPS RF state processing unit 130 passes, the state of the RF GPS signal may be determined to be non-normal. This approach facilitates the addition of tests to check for other failure modes or anomalous states of the RF GPS Receiver (122/123), which is an indication of the state of the input RF GPS signal received by the GPS antenna 104. In some embodiments, when the RF GPS Receiver is determined to be operating in a normal state, an algorithm executing on the GPS RF state processing unit 130 may take advantage of the normal condition by measuring, adjusting, adapting, and/or calibrating one or more parameters used to perform the one or more tests; essentially, performing a recalibration of the GPS RF state processing unit 130. For example, during normal operation, the GPS RF state processing unit 130 may be configured to average or filter the nominal GPS satellite power levels and noise levels and use them to dynamically adjust prescribed thresholds to fine tune the thresholds and account for differences between different instances of the same platform.

One or more alert signals generated by the combined GPS spoofing and jamming detection module 224, upon the detection of potential GPS spoofing or jamming events, may be provided to a gauge cluster module 226. The gauge cluster module 226, in one or more embodiments, is essentially a user interface configured to receive the one or more alert signals provided by the combined GPS spoofing and jamming detection module 224 and to present the alert signals to a user, for example in the form of a visual alert (e.g., display, light, etc.), an audible alert (e.g., speaker), and/or a tactile alert (e.g., haptic feedback device), so that the user can assess the threat level and perform one or more actions in response thereto. In some embodiments, the gauge cluster module 226 may incorporate data processing capabilities (e.g., artificial intelligence (AI), etc.) to collect historical data for better assessing the threat indicated by a given alert signal. In other embodiments, the gauge cluster module 226 may be configured to automatically implement effective countermeasures in response to the received alert signal. The gauge cluster module 226, in one or more embodiments, may comprise a user interface in the form of a web-based application, presenting data that is stored and indexed using a security information and event management system, such as, for example, Splunk® (a registered trademark of Splunk Inc.).

The GPS jamming and/or spoofing detection system according to aspects of the inventive concept (e.g., system 100 shown in FIG. 1, or system 200 shown in FIG. 2) may be configured to operate in at least one of a serial-only detection mode or an RF-only detection mode. With reference to FIGS. 1 and 2, in a serial-only detection mode of operation according to one or more embodiments, the GPS jamming and/or spoofing detection system 100, 200 may omit certain components that are used solely for processing the RF GPS signal, such as, for example, the GPS RF signal processing unit 123 and the GPS RF state processing unit 130. The intake module may also be modified to eliminate the input connection to the RF splitter 106 for receiving the RF GPS signal and corresponding components used to format the RF GPS signal into a digital signal (e.g., software-defined radio). Likewise, in an RF-only detection mode, the GPS jamming and/or spoofing detection system 100, 200 may omit certain components that are used solely for processing serial data, such as, for example, the serial-only detection module 132. The intake module 122 may also be modified to eliminate components used for formatting the raw serial data obtained from the serial bus 110.

In a serial-only detection mode of operation according to one or more embodiments, GPS spoofing and jamming detection may be implemented in a stateful module (e.g., GPS spoofing and jamming detection module 138 in FIG. 1, or combined GPS spoofing and jamming detection module 224 in FIG. 2) configured to detect instances of GPS spoofing and/or jamming using data from one or more GPS receivers (e.g., GPS receiver 102 in FIGS. 1 and 2), such as may be incorporated in an LRN and/or from an LRU (e.g., aircraft computer module) connected together on a serial bus (e.g., serial bus 110 in FIGS. 1 and 2) and communicating using a serial bus protocol (e.g., ARINC-429). For example, the stateful module may be configured to read messages from the serial bus to construct complete sets of coordinates, and then compare at least two sets of coordinates to calculate the aircraft's velocity (in the case of an aircraft, as an example). If the aircraft is traveling at what is determined to be an unrealistic speed, the stateful module will generate an alert due to suspected GPS spoofing. Alternatively or in addition, the stateful module may be configured to generate an alert if it is determined that the aircraft is in flight (as determined by altitude and velocity) but has an unusually long duration where it has failed to lock onto enough satellites to calculate a position. This may be an indication of GPS jamming.

The GPS spoofing and jamming detection method according to embodiments of the inventive concept may further utilize inertial measurements, such as from an IRU including an INS module (e.g., INS module 112 in FIGS. 1 and 2) communicating on the serial bus using, for example, an ASCB communication protocol, to compare the inertial position to the GPS position of the aircraft. The stateful module may be configured to generate an alert if the inertial position diverges beyond a prescribed range from the GPS position over a certain window of time. This feature is designed to detect more subtle cases of GPS spoofing where the spoofing occurs gradually, rather than suddenly (i.e., large jumps in position).

In order to accomplish this, the stateful module implementing the GPS spoofing and jamming detection methodology according to aspects of the inventive concept may be configured to correct for at least two factors: first, that the IRU's initial position is hard-coded or input by a user (e.g., flight crew), so it will differ from the aircraft's true position from the moment the aircraft is powered on; or second, that the IRU's position is susceptible to drift due to the imperfect nature of the sensors (e.g., inertial sensors 114 in FIGS. 1 and 2) and measurement equipment involved. To account for this, the stateful module may maintain historical position data to keep track of the shift or delta (i.e., difference) between the GPS position and IRU position based on a sliding window that goes back in time by a prescribed amount (e.g., a few minutes). When comparing the GPS position to the IRU position to detect spoofing, the oldest valid shift, no older than a prescribed historical age (e.g., about two minutes), is applied to the IRU's reported location to ensure that the initial position mismatch and a normal (expected) drift of the inertial measurements are cancelled out to the greatest extent possible. From that point on, any significant amount of divergence between the GPS position and the shifted IRU position could be an indication of gradual GPS spoofing that falls below the threshold of what the original GPS spoofing methodology would detect, or what a pilot may even notice. This additional feature enables the stateful module to detect spoofing where the aircraft's heading is altered slightly so that it is only, for example, a couple thousand meters away from its reported position after several minutes of flight.

In some embodiments, the stateful module implementing the GPS spoofing and jamming detection methodology according to aspects of the inventive concept may be configured to perform an analysis of a timing difference between the GPS UTC (Coordinated Universal Time) time, a global time standard that synchronizes clocks and timekeeping devices worldwide, and the message ticks value to look for cases where the GPS time may have been affected by spoofing. In addition, the stateful module may be configured to generate an alert when there is a large gap in messages while the aircraft is in flight, which could be an indication of the LRN rebooting. Rebooting while in flight is a rare event, and events of this nature might indicate maintenance issues or cyber-related anomalies.

In order to implement this feature, the stateful module looks for message gaps that occur while the aircraft is in flight. These gaps may be attributable to one or more of several possible events, including, but not limited to, the LRN (e.g., GPS receiver 102 in FIGS. 1 and 2) being rebooted, the manifold (e.g., 120 in FIGS. 1 and 220 in FIG. 2) being rebooted, and a collector (e.g., intake module 122, or other data-gathering hardware or software implementation, including a capture card, transceiver, software-defined radio, etc.) being rebooted. The stateful module implementing the GPS spoofing and jamming detection methodology according to aspects of the inventive concept may be configured to distinguish which of the above events has occurred and to generate an appropriate alert in response.

In some embodiments, the stateful module implementing the GPS spoofing and jamming detection methodology according to aspects of the inventive concept may be configured to keep track of alerts that occurred on one of the LRN channels (e.g., LRN #1 or LRN #2) and to modify a new alert when another alert is detected on another one of the LRN channels within a prescribed window of time. Modifying an alert, according to some embodiments, may involve adding information to the alert about whether the alert occurred from multiple (e.g., two) LRNs or just one. By way of example only and without limitation, when an alert occurs on two LRNs, the alert may be modified by adding a field to a JavaScript object notation (JSON) map to provide an alert indication on both LRNs. This feature is designed to assist analysts in prioritizing their alert triage efforts, since GPS spoofing or jamming that affects both LRN channels (e.g., LRN #1 and LRN #2) are more likely to be attributable to actual GPS signal problems, rather than a temporary glitch in a single LRN.

The GPS spoofing and jamming detection methodology may be configured to generate alerts on several different types of conditions, and the GPS spoofing and jamming detection methodology may be easily reconfigured to modify the types of conditions that the GPS spoofing and jamming detection methodology checks for as well as the corresponding alerts that are issued when such conditions are detected. In one or more embodiments, these alerts are generated under conditions that rule out false positives. For instance, an aircraft must be in flight (i.e., moving), and for spoofing alerts, the GPS must be in a valid navigation mode, meaning that the GPS receiver has locked onto a sufficient number of satellites to produce an accurate position solution. Moreover, ARINC-429 messages should have valid SSM (sign status matrix) bits and ASCB messages should be in a valid system_status mode. Otherwise, the messages should be discarded and the current state of the GPS spoofing and jamming detection methodology should be cleared (i.e., wiped clean). The same may occur if there are large gaps in time between received messages, or if expected message types are received out of order.

The GPS spoofing and jamming detection methodology (i.e., algorithm) according to one or more embodiments may process inertial data (e.g., from an INS module of an IRU) and GPS data (e.g., from a GPS receiver in an LRN) differently. As an alternative to calculating a shift between GPS position data and inertial sensor position data based on stored historic differences (i.e., deltas) between the two coordinates, one or more embodiments of the GPS spoofing and jamming detection methodology may utilize an infinite impulse response (IIR) filter, or recursive filter. This alternative approach may be configured to continuously update an expected magnitude of the difference between the IRU and GPS coordinates based on a prescribed algorithm and some tunable coefficients and parameters. This means that ordinary drift between the IRU and GPS coordinates is taken into account and used to update the IIR or recursive filter. However, if the rate of divergence suddenly increases beyond a prescribed threshold and the total magnitude of the difference rises above the threshold, then an alert is triggered. This is a more precise approach that is able to determine the presence of a spoofed state for longer, while the filter has not yet had time to be adapted to include the spoofed state. One downside of this approach is that it may require precise tuning to ensure that extremely dynamic flights that may cause the IRU to drift more rapidly do not trigger false positive alerts.

In one or more embodiments, the prescribed algorithm to update the expected magnitude of the difference between the IRU and GPS coordinates may be implemented as an adaptive IIR filter; that is, the algorithm may be configured to perform an IIR filter function on a difference in distance between the IRU and GPS points. The IIR filter coefficient is adaptive and varies based on an instantaneous change between the difference of the IRU and GPS points and the IIR filtered difference of the IRU and GPS points. Under normal conditions, the difference between the IRU and GPS points can be non-zero because the IRU may drift. If not calibrated, the difference from the drift can remain. When considering an aircraft that has an IRU and GPS, as the aircraft moves under normal (i.e., non-spoof) conditions, the positions from the IRU and GPS should move in unison and the difference between them will remain the same except for the drift of the IRU. Filter coefficients and other parameters for the IIR are used to filter or average that difference to allow for normal drift and at the same time maintain a normal or expected filtered difference between the IRU and GPS.

Under non-normal conditions when a spoof occurs, the GPS points will begin to change faster than the IRU points and create a difference between the IRU and GPS points above a normal rate. The algorithm will compare the difference between the instantaneous difference between the IRU and GPS points and the IIR filtered difference between the IRU and GPS points and trigger an alert when that change exceeds a configurable threshold. Also, as the difference between the instantaneous difference and the IIR filtered difference increases, the amount of IIR filtering adapts to increase the filtering to maintain the previous “normal” difference prior to spoofing.

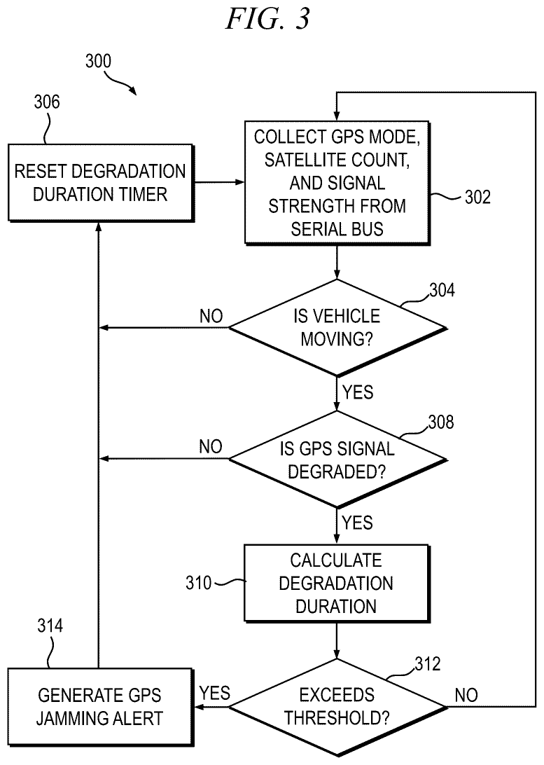

FIG. 3 is a flow diagram depicting at least a portion of an exemplary method 300 for detecting the potential presence of GPS jamming and generating a GPS jamming alert in response thereto, according to one or more embodiments of the inventive concept. The method 300 may be performed, for example, as part of an operation of the GPS spoofing and jamming detection module (e.g., 138 in FIG. 1 or 224 in FIG. 2).

By way of example only and without limitation, in the case of an illustrative aircraft application, a GPS jamming alert may be generated when it is assumed that the aircraft (or other asset) is in flight or otherwise moving but a significant length of time is detected where satellite visibility count is low, or the GPS receiver remains in a non-navigation mode, such as an acquisition state. An “acquisition state” of a GPS receiver generally refers to a process of the GPS receiver detecting and identifying GPS satellite signals, including estimating Doppler frequency offset and code phase offset, which is typically an initial step in enabling GPS navigation. The current satellite count and GPS mode of the GPS receiver may be obtained from ARINC-429 messages. For every new set of coordinates completed, the satellite count and the mode of the GPS receiver are obtained. If the satellite count is below a prescribed threshold (e.g., six or less), or if the GPS mode is not one of the valid navigation modes (e.g., ground-based augmentation system (GBAS)/ground-based regional augmentation system (GRAS) navigation (NAV), satellite-based augmentation system navigation (SBAS NAV), SBAS APPROACH, etc.), a timer is initiated. For every new message that is received, the status of the GPS receiver is checked to see if the GPS receiver has recovered from its degraded conditions and, if so, the timer is cleared. Otherwise, if the degradation continues for a length of time which exceeds a prescribed threshold (e.g., 60 seconds), the aircraft is likely experiencing a jamming event and a jamming alert is generated. Additionally, a jamming alert may not be generated when there has been a large message gap recently. This is to avoid false positives caused by the LRNAV unit (e.g., GPS receiver 102 in FIGS. 1 and 2) rebooting during flight, and needing to reacquire satellite lock. This situation closely resembles GPS spoofing, and is therefore distinguished using a separate alert to avoid confusion.

Referring to FIGS. 1-3 , the method 300, in step 302, collects information from the serial data bus 110. Such information may relate to the received GPS signals and may include, for example, GPS mode, satellite count (i.e., the number of satellites providing GPS data, or used in the position solution) and signal strength relating to the received GPS signals from the GPS receiver 102. In step 304, the method 300 determines whether the vehicle/asset (e.g., aircraft, automobile, watercraft, etc.) is moving (i.e., not stationary). This can be determined using GPS data, inertial sensor data, or other movement detection means.

The determination in step 304 as to whether the vehicle is moving is not necessarily performed to check whether the vehicle's position has changed. Rather, in the case of an aircraft, it determines whether the vehicle is in flight or not. This is because an aircraft that is on the ground and/or in a hangar may generate false positives due to interference caused by nearby structures. While the aircraft is in flight, however, such interference is unlikely and therefore any degradation in the received GPS signal is more likely to be a result of malicious activity (e.g., GPS jamming). The same reasoning holds true for ground assets, such as an automobile. A stationary automobile (e.g., parked in a garage) could be subjected to interference which may generate false positives; such interference is unlikely to occur while the vehicle is moving, particularly when the GPS signals are monitored over a prescribed period of time.

If the vehicle is not moving, as determined in step 304, a degradation duration timer, which determines the duration of time that the GPS signal is degraded, is reset in step 306 and the method 300 proceeds to step 302 to continue collecting information from the serial data bus 110. If the vehicle is determined in step 304 to be moving, the method 300 checks to see whether the GPS signal is degraded in step 308. If the GPS signal is not degraded, the method 300 resets the degradation duration timer in step 306 and continues to collect information from the serial data bus 110 in step 302. If the GPS signal is determined to be degraded in step 308, the method 300 calculates the degradation duration in step 310. This calculation may be performed, for example, by obtaining a value of the degradation duration timer or other method for determining the amount of elapsed time during which the GPS signal has been degraded.

The value of the degradation duration timer is checked in step 312 against a prescribed threshold value to determine whether the degradation duration timer has exceeded the prescribed threshold. If the prescribed threshold for the degradation duration timer has not been exceeded, the method 300 continues in step 302 to collect GPS signal information from the serial data bus 110. If the prescribed threshold for the degradation duration timer has been exceeded, a GPS jamming alert signal may be generated in step 314. The method then resets the degradation duration timer in step 306 and continues collecting GPS signal information from the serial data bus 110.

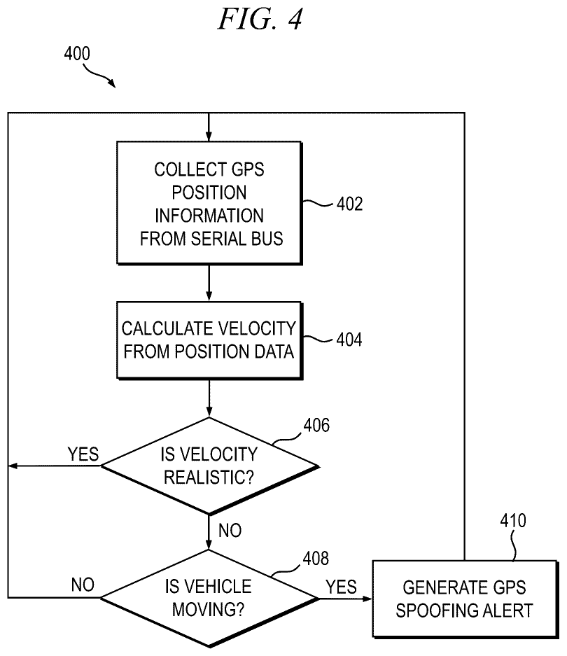

FIG. 4 depicts a flow diagram describing an exemplary method 400 for detecting the potential presence of GPS spoofing and generating a GPS spoofing alert in response thereto, according to one or more embodiments. The method 400 may be performed, for example, as part of the operation of the GPS spoofing and jamming detection module (e.g., 138 in FIG. 1 or 224 in FIG. 2). The GPS spoofing alert may be generated when large changes to an asset's position are detected using data from the ARINC-429 bus, and/or another serial bus(es); information from one or more other buses may be used to improve fidelity and reduce false positive rate. In one or more example embodiments, complete sets of coordinates are added to a double-ended queue of, for example, the last ten measurements. Assuming one measurement is obtained every 100 milliseconds (ms), this represents the most recent one second of data. Once a set of coordinates is completed, the method 400 may check for spoofing by computing the instantaneous velocity of the aircraft using the distance between the most recent set of coordinates and the one before it. In one or more embodiments, only two-dimensional coordinates are used, not altitude (purely due to the high degree of unreliability with altitude measurements). This velocity is compared against a threshold value for the maximum speed one could reasonably expect the aircraft to travel plus some cushion to avoid false positives. For aircraft, as an example, the threshold value may be set to 600 miles per hour (MPH), although embodiments are not limited thereto. If the velocity exceeds the threshold, a check is performed to ensure the aircraft is in flight, again to reduce the likelihood of false positives. This is done using only data on the same bus currently, so two parameters may be checked: the height of the aircraft above some threshold value; and the average velocity of the previous sets of coordinates (not the most recent one) above some threshold value. If these threshold values are exceeded, then the aircraft is assumed to be in flight, and therefore the large velocity is likely due to GPS spoofing and a GPS spoofing alert is generated.

More particularly, referring to FIGS. 1, 2 and 4, the GPS spoofing detection method 400, in step 402, collects information from the serial data bus 110. Such information may relate to the received GPS signals and include, for example, GPS position data relating to an asset (e.g., aircraft, automobile, watercraft, etc.). In step 404, the method 400 calculates a velocity of the asset from the received GPS position data obtained from the serial data bus 110. In one or more embodiments, the GPS spoofing and jamming detection module 138, 224 may be configured to read a plurality of messages obtained from the serial data bus 110 (each having a timestamp associated therewith) to construct complete sets of coordinates, and then to compare two or more sets of coordinates to calculate the asset's velocity. The velocity may be calculated by comparing two or more measurements of the asset's position, and then calculating the distance and time between those two measurements to determine velocity. In some embodiments, other factors, such as, for example, altitude, engine revolutions per minute (RPM), tire rotation speed, etc., may alternatively or additionally be used to compare changes in velocity to determine whether such a change in velocity is realistic within the context of other physical measurements transmitted on the serial bus 110.

In step 406, the method 400 determines whether or not the calculated velocity of the asset is realistic (i.e., valid). The determination as to whether a calculated asset velocity is valid or invalid may be made, in one or more embodiments, by comparing the calculated velocity of the asset with a prescribed reference velocity or range of velocities. For example, when the calculated velocity of the asset in step 406 is greater than a prescribed maximum velocity or when the calculated velocity of the asset falls outside of a prescribed range of velocities, the velocity may be determined to be unrealistic (i.e., invalid). If the calculated velocity of the asset, based on GPS position data obtained from the serial data bus 110, is determined in step 406 to be realistic, the method 400 continues to collect GPS position information from the serial data bus 110 in step 402.

When step 406 determines that the calculated velocity of the asset is not realistic, the method 400 determines whether the asset is moving (i.e., inflight, driving, etc.) in step 408. If the asset is not moving, then an invalid asset velocity may not necessarily trigger the system to take any action or generate an alert, and the method 400 may continue to collect GPS position information from the serial data bus 110 in step 402. Alternatively, when step 408 determines that the asset is moving, a GPS spoofing alert may be generated in step 410, in real-time, indicating the presence of potential GPS spoofing. The GPS spoofing alert may comprise any notification in the form of a visual, audible and/or tactile indication. After generating the GPS spoofing alert, the method continues to collect GPS position information from the serial data bus 110 in step 402 and the process repeats.

The illustrative methods 300 and 400 described in FIGS. 3 and 4, respectively, demonstrate how the GPS spoofing and jamming detection system according to embodiments of the invention can beneficially distinguish between the presence of GPS jamming and GPS spoofing. For example, as an indication of GPS jamming (see FIG. 3), the GPS spoofing and jamming detection module (e.g., 138 in FIG. 1 or 224 in FIG. 2) may be configured to detect if the asset is moving (e.g., as may be determined using GPS position information, including altitude and/or velocity) but has an unusually long duration of time where it has failed to lock onto a sufficient number of satellites to calculate a position. As an indication of GPS spoofing (see FIG. 4), the GPS spoofing and jamming detection module may be configured to detect whether a velocity of the asset, as calculated using received GPS position data, is unrealistic.

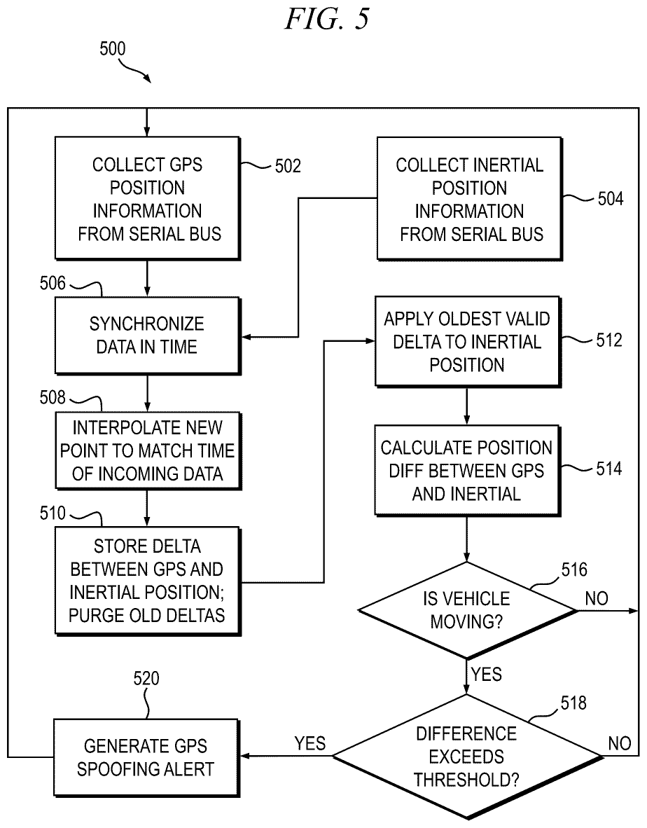

In some instances, subtle GPS spoofing may occur that would otherwise elude the GPS spoofing detection methodology described in connection with FIG. 4. By way of example only and without limitation, FIG. 5 depicts a flow diagram describing an exemplary method 500 for determining whether there is a subtle GPS spoofing attempt based on multiple data sources and generating an alert in response thereto, according to one or more embodiments. The method 500 may be performed, for example, as part of the operation of the GPS spoofing and jamming detection module (e.g., 138 in FIG. 1 or 224 in FIG. 2). The subtle GPS spoofing alert may be generated when an asset's position diverges too far from the IRU's reported position. Furthermore, this subtle GPS spoofing alert does not require the asset (e.g., aircraft) to be moving at an unrealistic speed, so it can be used to detect spoofing that introduces subtle, gradual changes to the asset's position.

The subtle GPS spoofing detection method 500 is a more complex detection method, compared to the GPS spoofing method 400 previously described in conjunction with FIG. 4, primarily because it utilizes position information from at least two different sources on at least two different sources (e.g., from an LRN communicating on the ARINC-429 bus as well as from an IRU communicating on the ASCB bus), and so must synchronize information between the two buses even when messages are read from the respective buses out of chronological order. It is to be appreciated that the at least two different sources from which position information is obtained may not necessarily be from two different buses. For example, if a single bus contains both GPS position information and inertial position information, then only one bus is required. The position information may even be obtained from a single LRU on that bus. The subtle GPS spoofing method 500 should be able to address the fact that the IRU's starting position is set manually and often disagrees with the GPS position from the onset. The method 500 should also be able to address normal drift that may occur from inertial measurements due to the imprecise nature of the hardware used to obtain the position measurements.

To address these other issues, the method 500, in one or more embodiments, may keep track of a difference (i.e., delta) between the two positions of the asset obtained from the different respective communication buses over time, which may be referred to herein as a “shift” value. Whenever a new inertial position comes in, it is shifted by an amount that represents the delta in the positions at a previous point in time (e.g., up to 2 minutes). This accounts for the initial difference between the positions as well as any normal drift, up until the point that the shift was calculated. Any further difference between the GPS and IRU position information is assumed to be attributable to either gradual drift since the previous position sample (e.g., within the last 2 minutes), or subtle (i.e., gradual) GPS spoofing introduced since the previous sample period. Therefore, the positions are compared and evaluated against a prescribed distance threshold (e.g., about 2000 meters for aircraft). If the distance exceeds that prescribed threshold, it is likely caused by subtle GPS spoofing and a subtle GPS spoofing alert is generated. For ASCB data, the method 500 may be configured to determine whether the aircraft is in flight or not by looking at ASCB data, such as, for example, the WOW_STATUS field, since weight-on-wheels status is a more reliable parameter than using altitude and velocity of the aircraft.

Referring now to FIGS. 1, 2 and 5, the subtle GPS spoofing detection method 500, in step 502, collects information from the serial data bus 110. Such information may relate to the received GPS signals and include, for example, GPS position data relating to an asset/vehicle (e.g., aircraft, automobile, watercraft, etc.). In step 504, inertial position information is collected from the serial data bus 110 (e.g., generated by the INS module 112). This inertial position information obtained in step 504 and the GPS position data obtained in step 502 are synchronized in time in step 506 for subsequent comparison.

Based on the time-synchronized position data provided in step 506, the subtle GPS spoofing detection method 500 may be configured to interpolate a new data point to match a time of incoming data in step 508. A difference (i.e., delta) between the GPS position data relating to the asset and the inertial position data relating to the asset is stored in step 510. In some embodiments, only a certain amount of historical difference data may be stored (for example, based on memory constraints, etc.); that is, a certain amount of historical difference data may be purged from storage so that the system is only storing a prescribed number of most recent historical difference calculations. In step 512, the oldest valid difference data is applied to the inertial position information. A difference between the GPS position data and the inertial position data is calculated in step 514.

The difference between the GPS position data for the asset and the inertial position data for the same point in time may be used to determine whether the asset is moving (e.g., in flight or driving) in step 516. If the vehicle is not moving, as may be determined by comparing two historical difference calculations to see if there is a change in position as a function of time (i.e., a measure of speed), the method 500 returns to step 502 where it continues to collect GPS position information from the serial data bus 110. If it is determined in step 516 that the asset is moving, the method 500 determines whether the difference between the GPS position data and the inertial position data exceeds a prescribed threshold value in step 518.

When the difference between the GPS position data and the inertial position data for the asset, as determined in step 518, does not exceed the prescribed threshold value, the method 500 continues to collect GPS position information from the serial data bus 110 in step 502 without generating a GPS spoofing alert signal. When the difference between the GPS position data and the inertial position data for the asset exceeds the prescribed threshold value, a GPS spoofing alert signal is generated in step 520, and the subtle GPS spoofing detection method 500 then continues to collect GPS position information from the serial data bus 110 in step 502.

By obtaining the inertial position data for the asset and the GPS position data for the asset and comparing the two data points synchronized in time, the subtle GPS spoofing detection method 500 is able to track the difference between the GPS position data and the inertial position data and generate a GPS spoofing alert when the GPS position data diverges too far from the inertial position data over a prescribed window of time. This feature is designed to detect more subtle cases of GPS spoofing where the spoofing occurs gradually, rather than only detecting sudden, large jumps in the position of the asset.

In one or more embodiments, the GPS spoofing and jamming detection module 138, 224 (see FIGS. 1 and 2) may be configured to generate a GPS timing anomaly alert when the difference between the GPS UTC time and the ticks value of a message begins to diverge. The “ticks value” may be defined by the system hardware clock and generally references a clock cycle or some integer multiple of the clock cycle. In the context of a system clock, “ticks” represent a unit of time, typically the smallest increment a hardware clock uses to measure elapsed time. The ticks value may be recorded by the manifold operating system (e.g., manifold 120 in FIG. 1, or manifold 220 in FIG. 2) at the time the serial bus message is collected. Since the ticks value is based on the hardware clock provided to the manifold (e.g., 120 in FIG. 1 or 220 in FIG. 2), it provides a relatively steady reference source of ground truth on timing.

The GPS time is determined from the timing information provided to it by the GPS satellite constellation. During GPS spoofing attacks, the calculated GPS time could change dramatically or just subtly, depending on the nature of the attack. This GPS timing anomaly alert is intended to draw attention to times when the GPS time changes rapidly in either direction. Simply looking for a difference between GPS time and ticks may not be effective because there is generally always some amount of difference between the two, however small. Instead, the GPS spoofing and jamming detection module 138, 224 (see FIGS. 1 and 2) may be configured to keep track of what a “normal” difference looks like, and only alert if the difference between the GPS time and the ticks exceeds a prescribed upper or lower bound for the expected (i.e., normal) difference, based on some level of tolerance. This might indicate that GPS spoofing is occurring, even if other methods of detecting GPS spoofing have not been triggered.

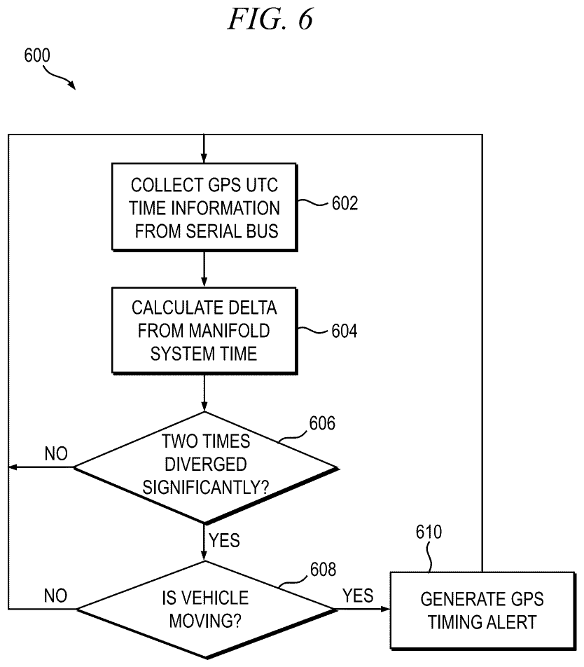

FIG. 6 is a flow diagram depicting an exemplary method 600 for determining whether there is a GPS timing anomaly and generating an alert in response thereto, according to one or more embodiments of the inventive concept. The method 600, or at least a portion thereof, may be performed by the GPS spoofing and jamming detection module 138, 224 (see FIGS. 1 and 2). Referring to FIGS. 1, 2 and 6, GPS UTC time information, or another reference time source, is collected from the serial data bus 110 (e.g., generated by the INS module 112) in step 602. This GPS UTC time information obtained in step 602 is compared against the manifold system time (e.g., system hardware clock) in step 604 and a difference (i.e., delta) between the GPS UTC time information and the ticks value (system or global clock) is calculated for subsequent analysis. In step 606, the timing difference calculated in step 604 is compared to a prescribed threshold to determine whether the timing information diverges beyond the prescribed threshold.

When the GPS UTC time information and the ticks value do not diverge significantly from one another (i.e., the timing difference is within the prescribed threshold), as determined in step 606, the method 600 continues to collect GPS UTC time information from the serial data bus 110 in step 602. Alternatively, when step 606 determines that the GPS UTC time information and the ticks value are significantly different from one another, method 600 checks whether the asset is moving in step 608. When it is determined that the asset is not moving, the method 600 continues to collect GPS UTC time information from the serial data bus 110 in step 602. Alternatively, when it is determined that the asset is moving, a GPS timing alert is generated in step 610 and the method 600 then continues to collect GPS UTC time information from the serial data bus 110 in step 602.

The GPS jamming and/or spoofing detection system (e.g., 100 and 200 shown in FIGS. 1 and 2, respectively) may be configured to perform GPS RF signal processing in an RF-only detection methodology, according to one or more embodiments of the inventive concept. The processing module (“manifold”) 120, 220 may form at least a part of a front end portion of the GPS jamming and/or spoofing detection system 100, 200 shown in FIGS. 1 and 2. In one or more example embodiments, the front end portion may filter and digitize GPS signals at a prescribed sample rate (e.g., 4.096 mega samples per second (MSPS)) and stream the complex samples to a software input buffer. At a regular interval, which may be referred to herein as an update rate, the software will take a snapshot of that data and send it to a processing unit for further processing (e.g., GPS spoof detection processing software). The interval may be configurable and vary based on available computing power. In an illustrative embodiment, the software may be configured to take eight millisecond (ms) snapshots every one second, although embodiments are not limited to any particular update interval. The snapshot of data is subsequently processed to search for the presence of GPS satellites.

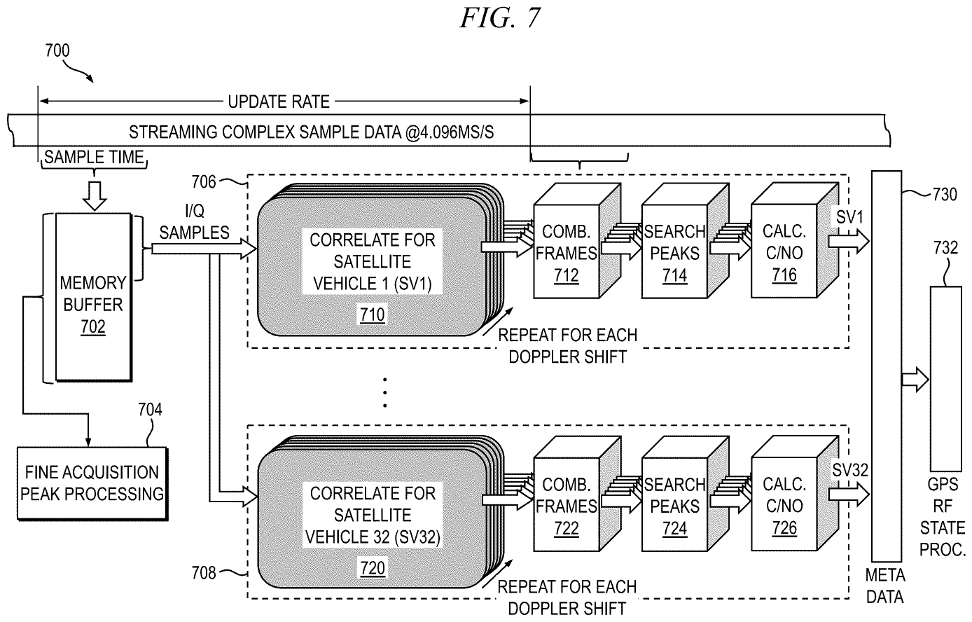

FIG. 7 is a block diagram depicting an example implementation of a GPS RF signal processing unit 700 suitable for use in the GPS jamming and/or spoofing detection system configured for RF-only GPS spoofing detection, according to one or more embodiments of the inventive concept. The GPS RF signal processing unit 700, which may be consistent with the GPS RF signal processing unit 123 shown in FIGS. 1 and 2, includes a memory buffer 702 configured to receive and store a snapshot of data in a complex sample data stream provided by the front end portion. The snapshot of data may correspond to data received from the data stream during a given sample time (e.g., 8 ms). Data stored in the memory buffer 702 may be provided to a fine acquisition peak processing unit 704 configured to detect a peak magnitude of GPS data samples.

The fine acquisition peak processing unit 704, which may be optionally included in the GPS RF signal processing unit 700, may provide certain benefits in the unlikely scenario where a real GPS satellite signal and a spoofed GPS satellite signal (same satellite vehicle number or SVN) are aligned very closely in time such that it is not possible to distinguish between the two signals and detect the anomaly and spoof state. The fine acquisition peak processing unit 704 may be configured to use the frequency and time information from the coarse acquisition to further refine the detection by processing much more of the data only at that frequency and time. The more data or longer sample time that is used, the more resolute the detection becomes (i.e., enhanced detection resolution) allowing the processing to detect the two instances.

In-phase and quadrature (I/Q) components of the complex sample data stream (I/Q samples) obtained from the memory buffer 702 are provided to a plurality of processing pipelines 706 through 708. In one or more embodiments, a processing pipeline 706, 708 is provided for each satellite vehicle (SV) among a constellation of satellite vehicles. In the example embodiment shown, 32 processing pipelines are included corresponding to SV1 through SV32 representing the 32 satellites in the GPS constellation. It is to be appreciated, however, that embodiments of the inventive concept are not limited to operation with 32 satellite vehicles, but that a different number of satellite vehicles may be used (e.g., 24 satellite vehicles).

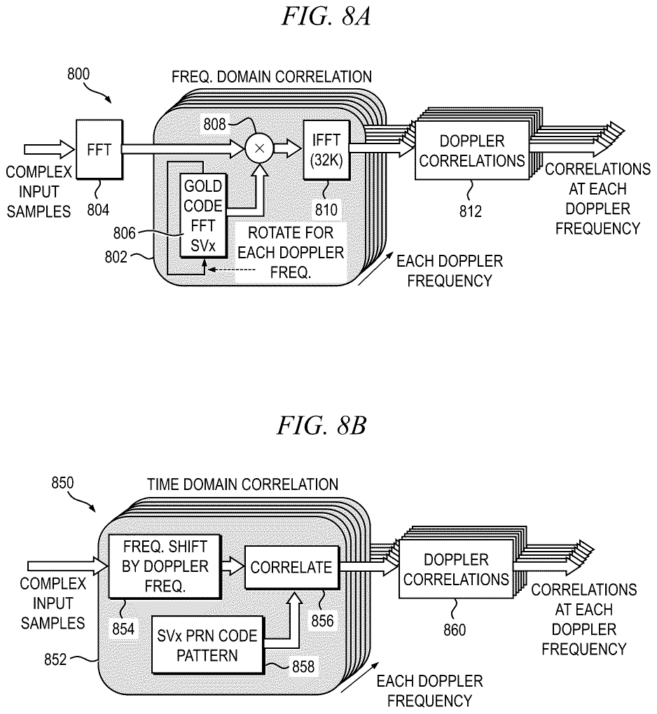

Each of the processing pipelines 706, 708 may include a correlation unit, a frame combing unit, a peak search unit, and a carrier-to-noise calculation unit. For example, a first processing pipeline 706 for processing data relating to satellite vehicle 1 comprises a first correlation unit 710 configured to receive I/Q samples as input from the memory buffer 702 and correlate GPS satellite pseudo-random noise (PRN) codes over an entire doppler range. In the context of GPS and satellite navigation, a PRN code is a unique sequence of 1023 bits used to identify each satellite and enable receivers to measure the distance to them, which is crucial for determining location. The correlation unit 710 is described in further detail below in conjunction with FIGS. 8A and 8B.

The first processing pipeline 706 further includes a first frame combining unit 712 configured to receive correlated samples from the first correlation unit 710 and provide combined GPS data frames to a first peak search unit 714. In an example embodiment, a GPS frame time may be assumed to be 1 ms. The snapshot size (i.e., sample time) is an integer multiple of 1 ms. In the case of an 8-ms sample time, eight consecutive GPS frames are correlated by the correlation unit 710, although embodiments are not limited thereto. The correlation output will contain as many correlation frames as there are time frames. The output will contain average correlation magnitudes for one GPS frame time (e.g., 1 ms). This average correlation will contain the carrier-to-noise ratio for that particular GPS satellite PRN code correlation. An output of the frame combining unit 712 will be subsequently used to determine an average noise floor and the carrier-to-noise ratio.

The first peak search unit 714 may be configured to search through doppler correlations for the corresponding first satellite vehicle SV1 to find two peaks having the largest magnitude (i.e., the top two peaks) and record the associated metadata, which may include a code phase (an index of the correlation where the peak is found), the peak magnitude, and doppler, among other information. The peaks may be at different times or code phases and at different dopplers. A peak are counted when the maximum magnitude is greater than both of the adjacent magnitude values, and if the peak index is at least 2 bins from the other peak found. Two peaks are always found and are validated as a real GPS satellite if the signal-to-noise ratio values exceed a prescribed threshold.

The first processing pipeline 706 further includes a first carrier-to-noise calculation unit 716 configured to calculate the carrier-to-noise ratio (C/No) of the doppler correlations for the first satellite vehicle SV1. The carrier-to-noise ratio is the correlation peak magnitude divided by the noise level. A GPS noise power calculation (i.e., noise level), in one or more embodiments, may be determined by finding a maximum hold values for each correlation bin output over all correlations performed at each doppler frequency. Once the maximum hold values have been found for each correlation bin, all the bins are averaged to obtain the noise floor value. The carrier-to-noise ratio for the first satellite vehicle SV1 is calculated by the first carrier-to-noise calculation unit 716 and saved for both peaks identified by the first peak search unit 714.

Similarly, a 32nd processing pipeline 708 for processing data relating to satellite vehicle 32 comprises a 32nd correlation unit 720 configured to receive I/Q samples as input from the memory buffer 702 and correlate GPS satellite PRN codes over an entire doppler range. The 32nd processing pipeline 708 further includes a 32nd frame combining unit 722 configured to receive correlated samples from the 32nd correlation unit 720 and provide combined GPS data frames to a 32nd peak search unit 724. The 32nd peak search unit 724 may be configured to search through doppler correlations for the 32nd satellite vehicle SV32 to find two peaks having the largest magnitude (i.e., the top two peaks) and record the associated metadata which includes a code phase, the peak magnitude, and doppler.

The 32nd processing pipeline 708 further includes a 32nd carrier-to-noise calculation unit 726 configured to calculate the carrier-to-noise ratio (C/No) of the doppler correlations for the 32nd satellite vehicle SV32. The carrier-to-noise ratio may be calculated in a manner consistent with the calculation method used for the first carrier-to-noise calculation unit 716 previously described. The carrier-to-noise ratio for the 32nd satellite vehicle SV32 is then saved for both peaks found.

Metadata 730 generated as outputs of the respective plurality of processing pipelines 706, 708 may include useful information about the GPS satellites that are present in the input snapshot. By way of example only and without limitation, the metadata 730 for each of the satellite vehicles (e.g., SV1 through SV32) may include one or more of the following information for each of the two maximum peaks found: peak magnitude, peak magnitude index, peak magnitude signal-to-noise ratio (SNR), and peak magnitude doppler. this information is provided to a GPS RF state processing unit 732 (e.g., GPS RF state processing unit 130 shown in FIGS. 1 and 2) to detect a GPS spoofing condition.

The GPS RF state processing unit 732 may be implemented and function in a manner consistent with the GPS RF state processing unit 130 shown in FIGS. 1 and 2. A primary function of the GPS RF state processing unit 732 is to determine whether there is a spoofed signal present on or otherwise affecting the input RF GPS signal, which is also provided to the GPS receiver 102 and may therefore affect an operation of the GPS receiver 102 (see FIGS. 1 and 2). The GPS RF state processing unit 732 may accomplish this by processing the metadata 730 provided, directly or indirectly (e.g., via the cloud storage 124 in FIG. 1), by the GPS RF signal processing unit (e.g., 123 in FIGS. 1 and 2). In one or more embodiments, the GPS RF state processing unit 732 is configured to evaluate a plurality of conditions which may indicate whether spoofing is occurring and set an output to a corresponding state indicative thereof. Additionally, the GPS RF state processing unit 732 may be configured to determine other non-spoofing states that can be useful in determining an operational status of the GPS receiver. In one or more embodiments, in order to determine whether a state of the GPS receiver is “normal,” the GPS RF state processing unit 732 may be configured to perform a series of tests that indicate a non-normal operation of the GPS receiver. If all of the tests fail, the GPS receiver is determined to be in a normal state. This approach facilitates the easy addition of tests to determine other failure and/or anomalous states of the GPS receiver.

FIGS. 8A and 8B are block diagrams depicting at least a portion of a correlation unit that may be employed in each of the processing pipelines 706, 708 in the illustrative GPS RF signal processing unit 700 shown in FIG. 7, according to one or more embodiments of the inventive concept. FIG. 8A depicts a correlation unit 800 configured to perform frequency domain correlation, and FIG. 8B depicts a correlation unit 850 configured to perform time domain correlation. The correlation units 800 and 850 shown in FIGS. 8A and 8B may represent example implementations of the correlation unit 710, 720 in each of the processing pipelines 706, 708 in FIG. 7, according to embodiments of the inventive concept.

Referring to FIG. 8A, the correlation unit 800 includes a plurality of frequency domain correlators 802, one for each doppler frequency, adapted to receive a fast Fourier transform (FFT) output of complex input samples from a given sample period (referred to herein as an “input snapshot”) provided to the correlation unit 800. Frequency domain correlation may be preferred over other correlation approaches in that it is an efficient way to perform the correlation function. In the frequency domain, correlation at each doppler may be performed by shifting the FFT output of the complex input samples with respect to the FFT output of the GPS PRN code (gold code, a binary sequence), which can be achieved using a gold code rotator 806, prior to performing a dot product of the FFT output and the shifted FFT output using a multiplier 808. An inverse FFT (IFFT) function is then performed on the dot product output of the multiplier 808 using an IFFT unit 810, or similar functional block. Each shift will represent a different doppler to generate doppler correlations 812 at each doppler frequency.

Referring to FIG. 8B, the correlation unit 850 includes a plurality of time domain correlators 852, one for each doppler frequency, adapted to receive complex input samples provided to the correlation unit 850. Each of the time domain correlators 852 includes a frequency shift unit 854 adapted to receive the complex input samples. The frequency shift unit 854 is configured to perform a frequency shift on the input samples by each doppler frequency, and the frequency-shifted input samples are provided to a correlate unit 856. The PRN code pattern for a given satellite vehicle (SVₓ) is generated by a PRN code pattern unit 858 and is provided to the correlate unit 856. The time domain correlators 852 are configured to generate doppler correlations 860 at each doppler frequency.

FIGS. 9A-9C is a flow diagram depicting at least a portion of an example method 900 which may be performed by the GPS RF state processing unit (e.g., 732 in FIG. 7), according to one or more embodiments of the inventive concept. Referring to FIGS. 9A-9C , metadata is provided to the GPS RF state processing unit in step 902. As previously stated, the metadata, which may be provided by the GPS RF signal processing unit 123 (see FIGS. 1 and 2), includes information which may be used by the GPS RF state processing unit to determine the state of the GPS receiver.

In step 904, the GPS receiver state processing method 900 may perform an average GPS power calculation. In one or more embodiments, the average GPS power calculation comprises determining a normalized power level of the detected GPS satellites and then averaging a correlation magnitude for all the satellites that exceed a prescribed SNR threshold. Under normal conditions with full visibility, the average GPS power calculation in step 904 may involve averaging about 10-12 satellites where the average value will remain relatively consistent. The average GPS power calculation generates an average noise floor value during normal operation. It is to be understood that embodiments are not limited to any particular number of satellites used to obtain the average GPS power calculation. In some embodiments, filtering may be used to determine a correct baseline during normal operation.

In step 906, an average number of satellites present may be determined. This process may involve simply counting the number of peaks, including the second highest peaks, that are above the prescribed SNR threshold for all satellites. Under normal conditions and with a full view of the sky, this number may be about 10-12 satellites on average, although embodiments are not limited thereto.

In steps 908 through 924, the GPS receiver state processing method 900 may be configured to perform a series of tests, each of which may be designed to determine if the GPS receiver is functioning in a non-normal manner. It is to be appreciated that one or more of these tests may be eliminated and/or one or more other tests not explicitly shown may be added. By way of example only and without limitation, a first test may be performed in step 908 to check whether no satellites are present and the noise floor is below prescribed normal levels. If it is determined that no satellites are present and the noise floor is below the prescribed normal levels, an alert signal is generated indicating that the GPS receiver has no input signal. Otherwise (i.e., when a failure of the first test is detected), a state of the GPS receiver is determined to be normal and the method 900 continues to perform the next test.

In step 910, a second test may be performed to check whether no satellites are present and the noise floor of the received by the GPS receiver is normal and below a prescribed jamming threshold. If it is determined that no satellites are present and the noise floor is normal and below the prescribed jamming threshold, an alert signal is generated indicating that the GPS receiver has no GPS signal. Otherwise (i.e., when a failure of the second test is detected), a state of the GPS receiver is determined to be normal and the method 900 continues to perform the next test.

In step 912, a third test may be performed to check whether the number of satellites received by the GPS receiver is greater than zero but below prescribed normal levels. If it is determined that the number of satellites is greater than zero but below the prescribed normal levels, an alert signal is generated indicating that there is a low GPS signal. Otherwise (i.e., when a failure of the third test is detected), a state of the GPS receiver is determined to be normal and the method 900 continues to perform the next test.

In step 914, a fourth test may be performed to check whether the number of satellites received by the GPS receiver is less than prescribed normal levels, and above a prescribed jamming threshold for a given hysteresis period. If it is determined that the number of satellites is less than the prescribed normal levels and above the prescribed jamming threshold (i.e., is above the noise floor), an alert signal is generated indicating that a jamming condition may be present. Otherwise (i.e., when a failure of the fourth test is detected), a state of the GPS receiver is determined to be normal and the method 900 continues to perform the next test. As previously stated, the average GPS power calculation will generate an average noise floor value during normal operation. When a current (non-normal) GPS power calculation exceeds the average GPS power calculation by some multiple or “jamming threshold,” the test meets this condition and an alert is generated.

In step 916, a fifth test may be performed to check whether the number of double peaks is above a prescribed SNR threshold greater than a limit for a given hysteresis time. If it is determined that the number of double peaks is above a prescribed SNR threshold greater than a limit for a given hysteresis time, an alert signal is generated indicating that a GPS double peak spoofing condition may be present. Otherwise (i.e., when a failure of the fifth test is detected), a state of the GPS receiver is determined to be normal and the method 900 continues to perform the next test.

In step 918, a sixth test may be performed to check whether an average GPS correlation peak power exceeds a prescribed threshold. If it is determined that the average GPS correlation peak power exceeds the prescribed threshold, an alert signal is generated indicating that a GPS overpower spoofing condition may be present. Otherwise (i.e., when a failure of the sixth test is detected), a state of the GPS receiver is determined to be normal and the method 900 continues to perform the next test.

In step 920, a seventh test may be performed to check whether there is an abnormal number of GPS satellites detected. If it is determined that there is an abnormal number of GPS satellites, an alert signal is generated indicating that a GPS abnormal number of satellites spoofing condition may be present. Otherwise (i.e., when a failure of the seventh test is detected), a state of the GPS receiver is determined to be normal and the method 900 continues to perform the next test.

In step 922, an eighth test may be performed to check whether there are abnormal GPS satellite power levels detected. This is different than the functions performed in step 918 in that step 922 is not looking for an absolute total power level but rather anomalies in the satellite power levels, such as, for example, when all the GPS satellite power levels are equal, which is an unlikely state with real GPS signals and more likely indicates that a spoofer has set all the power levels the same and did not try to generate the real GPS satellite power levels. When it is determined that there are abnormal GPS satellite power levels, an alert signal is generated indicating that a GPS abnormal power level spoofing condition may be present. Otherwise (i.e., when a failure of the eighth test is detected), a state of the GPS receiver is determined to be normal and the method 900 continues to perform the next test.

In step 924, a ninth test may be performed to check whether there are abnormal GPS satellite dopplers detected. As in step 922, step 924 is configured to look for an abnormal doppler characteristic. One example of an abnormal doppler characteristic might be if each satellite had the same doppler value. Another example of an abnormal doppler characteristic might be that all the dopplers are static, meaning they are not changing or have no doppler rate. Step 924 may also look for a constant “common” doppler which may indicate a spoof event which transmits all the combined satellites onto one RF signal which will have one common doppler. If it is determined that there are abnormal GPS satellite dopplers, an alert signal is generated indicating that a GPS abnormal doppler spoofing condition may be present. Otherwise (i.e., when a failure of the ninth test is detected), a state of the GPS receiver is determined to be normal.

The method 900 is configured such that if all the GPS receiver status tests performed in steps 908 through 924 fail (i.e., produces a “false” result), a signal may be generated in step 926 indicating that the GPS receiver is operating in a normal state. The method 900 performed by the GPS receiver state processing unit is configured to process the input metadata and to generate a multi-level warning when any one or more of the status tests performed passes (i.e., produces a “true” result), indicating the relative signal level of the spoof GPS signal versus the real GPS signal. In one or more embodiments, when the GPS receiver is found to be operating in a normal state, signal power and noise filters may be updated, as well as satellite average, in step 926. In step 928, one or more GPS alert signals generated in any of steps 908 through 924 may be combined to generate a combined GPS alerts signal. An alert status may be generated in step 930 indicating a status of the GPS receiver, based at least in part on a combination of one or more GPS alert signals generated in steps 908 through 924. The method 900 then ends at step 932.

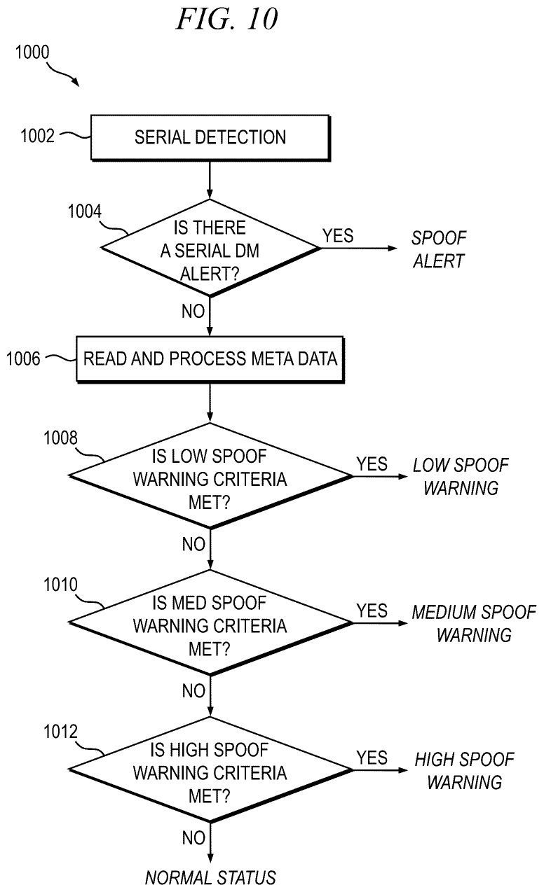

FIG. 10 is a flow diagram depicting at least a portion of an example combined GPS alerts method 1000 which may be performed in step 928 in FIG. 9C by the GPS receiver state processing unit (e.g., 732 in FIG. 7), according to one or more embodiments of the inventive concept. The combined GPS alerts method 1000 may be configured to combine information from the GPS receiver state processing unit functionality (e.g., method 900 shown in FIGS. 9A-9C) and the GPS spoofing serial detection functionality (e.g., method 500 shown in FIG. 5) to produce a comprehensive alert which includes a multi-level warning or threat indication up to and including a spoof detection alert indicating that the GPS receiver is being adversely affected by a spoof signal. In some embodiments, spoofing alerts generated by the combined GPS alerts method 1000 may include, for example, “low spoof warning,” “medium spoof warning,” “high spoof warning,” and “spoof alert,” each of which may be assigned to a particular threat level.

Referring to FIG. 10, in order to generate a multi-level warning or threat indication, the combined GPS alerts method 1000 performs a serial detection operation in step 1002. In step 1004, the method 1000 determines whether there is a serial GPS spoofing alert generated by the serial method operation in step 1002. When a GPS spoofing alert is detected, a spoof alert is generated by the combined GPS alerts method 1000. The spoof alert will supersede all other warnings/alerts generated by the combined GPS alerts method 1000.

When a GPS spoofing alert is not detected, the method 1000 continues by reading and processing metadata in step 1006, such as may be provided by a GPS RF signal processing unit (e.g., GPS RF signal processing unit 700 shown in FIG. 7). Various parameters may be obtained from the metadata in step 1006, including, for example, total GPS correlation magnitude, nominal filtered total GPS correlation magnitude, number of satellites detected, number of spoof satellites, and number of duplicate satellites, although embodiments are not limited to these or any specific parameters.

The “total GPS correlation magnitude” parameter may refer to a sum of all the magnitudes of the GPS PRN code correlations —-which may include both real GPS signals and spoofed GPS signals—that exceed a prescribed carrier-to-noise ratio threshold.

The “nominal filtered total GPS correlation magnitude” parameter may refer to a running average of the total GPS correlation magnitude and is only measured or updated when the GPS receiver state processing unit (e.g., 732 in FIG. 7) indicates that the GPS receiver is in a normal state (e.g., as performed in step 926 in FIG. 9C). The number of samples to average during normal operation may be configurable. For example, the number of samples may be averaged over a 30-minute time span, although embodiments are not limited thereto. This value is used as a baseline for comparing power levels during a spoof or non-normal state.

The “number of GPS satellites detected” parameter may refer to the number of distinct GPS PRN correlations that exceed a minimum configurable carrier-to-noise ratio threshold.

The “number of spoof satellites” parameter may refer to a difference between the number of GPS satellites detected and a nominal number of GPS satellites measured. The nominal number of GPS satellites measured may represent a running average of the “number of GPS satellites detected” when the GPS receiver state processing unit indicates that the GPS receiver is in a normal state.

The “duplicate satellites” parameter may refer to the number of satellites for which at least two GPS PRN correlations over the carrier-to-noise ratio threshold exist for the same PRN code.

Using the parameters obtained from the metadata read in step 1006, the combined GPS alerts method 1000 may perform a series of tests to determine successive spoofing threat levels and generate respective spoof warnings accordingly. For example, in step 1008, a first test may be performed by evaluating the parameters obtained from the metadata to determine whether low spoof warning criteria have been met. When the evaluated parameters meet the low spoof warning criteria in step 1008, a low spoof warning is generated.

In one or more example embodiments, the low spoof warning may be generated when the number of spoof satellites is greater than a prescribed number of spoof satellites threshold for a configurable consecutive number of times (e.g., 2-3 times), or the “number of duplicate satellites” parameter is greater than a prescribed duplicate satellites threshold for a configurable consecutive number of times (e.g., 2-3 times) and the “total GPS correlation magnitude” parameter is less than a prescribed low warning factor above the “nominal filtered total GPS correlation magnitude” parameter; the consecutive count is used to help prevent false detections. When there is no spoofing condition present, there will be no spoof satellites and no duplicate satellites detected, and the “total GPS correlation magnitude” and the “nominal filtered total GPS correlation magnitude” parameters will be approximately equal.

When the evaluated parameters do not meet the low spoof warning criteria in step 1008, the method 1000 may perform a second test in step 1010 by evaluating the parameters obtained from the metadata to determine whether medium spoof criteria have been met. When the evaluated parameters meet the medium spoof warning criteria in step 1010, a medium spoof warning is generated.

In one or more example embodiments, the medium spoof warning may be generated when the “number of spoof satellites” parameter is greater than the prescribed number of spoof satellites threshold for a configurable consecutive number of times (e.g., 2-3 times) or the “number of duplicate satellites” parameter is greater than the prescribed duplicate satellites threshold for a configurable consecutive number of times (e.g., 2-3 times) and the “total GPS correlation magnitude” parameter is greater than or equal to a prescribed low warning factor above the “nominal filtered total GPS correlation magnitude” parameter.

When the evaluated parameters do not meet the medium spoof warning criteria in step 1010, the method 1000 may perform a third test in step 1012 by evaluating the parameters obtained from the metadata to determine whether high spoof criteria have been met. When the evaluated parameters meet the high spoof warning criteria in step 1012, a high spoof warning is generated.

In one or more example embodiments, the high spoof warning may be generated when the “number of spoof satellites” parameter is less than the prescribed number of spoof satellites threshold and the “number of duplicate satellites” parameter is less than the prescribed duplicate satellites threshold and the “total GPS correlation magnitude” parameter has a power level that is greater than the “nominal filtered total GPS correlation magnitude” parameter by a prescribed high warning factor. The prescribed “high warning factor” may be configurable and may range, for example, between a multiple of 4 to 8 times, although embodiments are not limited thereto. In other words, the high warning level will be indicated when the spoof GPS signal power increases to a level where it greatly exceeds the “nominal filtered total GPS correlation magnitude” parameter and overpowers and suppresses the real GPS signal, thereby causing a low number of spoof satellites and duplicate satellites.

When the evaluated parameters do not meet the high spoof warning criteria in step 1012—that is, the combined GPS alerts method 1000 has not detected the presence of any alert conditions after evaluating the identified parameters against the various threat criteria, the GPS receiver is considered to be operating under normal status.

At least a portion of the techniques of the present invention may be implemented in an integrated circuit. In forming integrated circuits, identical die are typically fabricated in a repeated pattern on a surface of a semiconductor wafer. Each die includes a device described herein, and may include other structures and/or circuits. The individual die are cut or diced from the wafer, then packaged as an integrated circuit. One skilled in the art would know how to dice wafers and package die to produce integrated circuits. Any of the exemplary apparatus illustrated in the accompanying figures (e.g., the GPS jamming and/or spoofing detection system 100, 200 shown in FIGS. 1 and 2), or portions thereof, may be part of an integrated circuit. Integrated circuits so manufactured are considered part of this invention.

An integrated circuit in accordance with aspects of the present disclosure can be employed for detecting and alerting the presence of GPS jamming and/or spoofing in essentially any asset (e.g., aircraft, automobile, watercraft, etc.), among other applications. Systems incorporating such integrated circuits are considered part of this invention. Given the teachings of the present disclosure provided herein, one of ordinary skill in the art will be able to contemplate other implementations and applications of embodiments of the inventive concept.

Embodiments of the present invention, or portions thereof, may also be implemented in the form of a system, a method, and/or a computer program product. In one or more embodiments, the computer program product may include a non-transitory computer readable storage medium (or media) having computer readable program instructions thereon for causing a processor or other controller, such as, for example, the GPS RF signal processing unit 123 and/or the GPS receiver state processing unit 130 in the GPS jamming and/or spoofing detection system 100, 200 shown in FIGS. 1 and 2, to carry out aspects of the present inventive concept.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-limiting list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein, or portions thereof, may be downloaded to respective computing/processing devices from a computer readable storage medium or to an external computer or external storage device via a network, for example, the Internet, a local area network (LAN), a wide area network (WAN) and/or a wireless network (e.g., wireless LAN (WLAN)). The network may comprise copper transmission cables, optical transmission fibers, wireless transmission channels, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present inventive concept may be, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages, although embodiments are not limited thereto. The computer readable program instructions may execute entirely on a user's computer, partly on the user's computer, as a stand-alone software package, partly on the user's computer and partly on a remote computer or entirely on the remote computer or server. In the latter scenario, the remote computer may be connected to the user's computer through any type of wired or wireless network, including a LAN or a WAN, or the connection may be made to an external computer (for example, through the Internet using an Internet Service Provider). In some embodiments, electronic circuitry including, for example, programmable logic circuitry, field-programmable gate arrays (FPGAs), or programmable logic arrays (PLAs) may execute the computer readable program instructions, or portions thereof, by utilizing state information of the computer readable program instructions to personalize the electronic circuitry, in order to perform aspects of the present inventive concept.

Aspects of the present disclosure are described herein with reference to flowchart illustrations and/or block diagrams of methods, apparatus (systems), and computer program products according to embodiments of the invention. It will be understood that each of at least a subset of the blocks of the flowchart illustrations and/or block diagrams, and combinations of blocks in the flowchart illustrations and/or block diagrams, may be implemented by computer readable program instructions.

These computer readable program instructions may be provided to one or more processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises a unique article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block(s).

The example flowcharts and block diagrams depicted in the accompanying figures illustrate the architecture, functionality, and operation of possible implementations of systems, methods, and computer program products according to one or more embodiments of the invention. In this regard, each of at least a subset of the blocks in the block diagrams and/or flowchart illustrations may represent a module, segment, or portion of instructions, which comprises one or more executable instructions for implementing the specified function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that in one or more embodiments, each of at least a subset of blocks in the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

It will be understood that although ordinal terms, such as first, second, etc., may be used herein to describe various elements, these elements should not be limited by such terms. These terms are only used to distinguish one element from another, unless the context dictates otherwise. For example, a first element could be termed a second element, and, similarly, a second element could be termed a first element, without departing from the scope of the present disclosure.

The illustrations of embodiments of the invention described herein are intended to provide a general understanding of the various embodiments, and they are not intended to serve as a complete description of all the elements and features of the apparatus, systems and methods described herein. Many other embodiments will become apparent to those skilled in the art given the teachings herein; other embodiments may be utilized and derived therefrom, such that structural and logical substitutions and changes can be made without departing from the scope or spirit of the present disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein but within the scope of the present invention, will become apparent to those of skill in the art given the teachings herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or step-plus-function elements in the claims below are intended to include any structure, material, or act for performing the function in combination with other elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the various embodiments with various modifications as are suited to the particular use contemplated.

The abstract is provided herein to merely to quickly ascertain the basic nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus the following claims are hereby incorporated into the present Detailed Description, with each claim standing on its own as separately claimed subject matter.

Those skilled in the art will recognize improvements and modifications to the preferred embodiments of the present disclosure. All such improvements and modifications are considered within the scope of the concepts disclosed herein and the appended claims.

What is claimed is:

1. An apparatus for detecting global navigation satellite system (GNSS) spoofing and jamming in a moving asset, the apparatus comprising:
an intake module, the intake module configured to receive position data relating to the moving asset from a plurality of position data sources and to generate formatted position data based on the received position data; and
a spoofing and jamming detection module operatively coupled to the intake module, the spoofing and jamming detection module configured:
to receive the formatted position data, the formatted position data including GNSS information relating to the moving asset from a first position data source of the plurality of position data sources;
to determine whether a received GNSS signal is degraded based on the GNSS information received from the first position data source; and
to generate at least one of a GNSS jamming alert or a GNSS spoofing alert when a degradation of the GNSS signal exceeds a first prescribed threshold.

2. The apparatus according to claim 1, wherein the spoofing and jamming detection module is further configured:
to reset a degradation duration timer after generating the at least one of the GNSS jamming alert or the GNSS spoofing alert; and
to continue to receive the formatted position data.

3. The apparatus according to claim 1, wherein the plurality of position data sources comprises at least one GNSS receiver and at least one inertial navigation system (INS) module configured to provide position information relating to the moving asset based on motion information received from one or more inertial sensors.

4. The apparatus according to claim 1, wherein each of the plurality of position data sources is coupled to the intake module via a serial data bus.

5. The apparatus according to claim 1, wherein the intake module comprises a software-defined radio configured to format an analog waveform from a received radio frequency (RF) GNSS signal into a corresponding digital signal, the apparatus further comprising an RF signal processing unit, the RF signal processing unit configured:
to receive the formatted digital signal provided by the intake module; and
to extract metadata from the formatted digital signal, the metadata including information used to determine a state of a global positioning system (GPS) RF state processing unit in the spoofing and jamming detection module.

6. The apparatus according to claim 5, wherein the GPS RF state processing unit is configured:
to determine whether a jamming and/or spoofing event has occurred affecting the received RF GNSS signal, based at least in part on the metadata extracted from the formatted digital signal by the RF signal processing unit; and
to set an output of the combined spoofing and jamming detection module to a corresponding state indicative of whether a jamming and/or spoofing event is detected.

7. The apparatus according to claim 5, wherein the GPS RF state processing unit is configured to perform one or more tests, each of the one or more test indicating whether a corresponding anomaly is present in the received RF GNSS signal.

8. The apparatus according to claim 7, wherein the GPS RF state processing unit, in performing the one or more tests, is configured to detect at least one of:
multiple occurrences of a same GPS satellite;
a number of GPS satellites is less than a prescribed first threshold;
GPS satellite power levels that are outside a prescribed range of power levels;
average GPS correlation peak power that exceeds a prescribed second threshold; or
an abnormal doppler characteristic.

9. The apparatus according to claim 7, wherein the GPS RF state processing unit is configured to perform a recalibration of the GPS RF state processing unit when it is determined, based on performing the perform one or more tests, that the GPS RF state processing unit is operating in a normal state.

10. The apparatus according to claim 5, wherein the GPS RF state processing unit is configured to generate a first output signal indicative of a presence of a jamming and/or spoofing event, based at least in part on the metadata extracted from the formatted digital signal by the RF signal processing unit, and wherein the spoofing and jamming detection module further comprises:
a serial-only detection module, the serial-only detection module configured to obtain formatted data from the intake module and to generate a second output signal indicative of the presence of the jamming and/or spoofing event, based at least in part on the position data relating to the moving asset provided by one or more of the plurality of position data sources; and
a combined GPS alerts unit, the combined GPS alerts unit configured to receive the first and second output signals generated by the GPS RF state processing unit and the serial-only detection module, respectively, and to generate an alert signal based on the first and second output signals that has a reduced likelihood of a false positive.

11. The apparatus according to claim 10, wherein the combined GPS alerts unit is configured to execute one or more algorithms for performing at least one of noise filtering, asset movement verification, or valid GPS navigation mode validation.

12. The apparatus according to claim 1, further comprising a user interface, the user interface configured to receive an alert signal from the spoofing and jamming detection module and to present the alert signal to a user for assessing a threat level of a detected jamming and/or spoofing event.

13. The apparatus according to claim 12, wherein the alert signal is presented to the user as at least one of a visual alert, an audible alert, or a tactile alert.

14. The apparatus according to claim 1, wherein the spoofing and jamming detection module is further configured:
to determine a calculated velocity of the moving asset based on the formatted position data received from at least one of the plurality of position data sources;
to determine whether the calculated velocity of the moving asset is valid;
to determine whether the moving asset is moving; and
to generate a spoofing alert when it is determined that the calculated velocity of the moving asset is invalid and the moving asset is not subjected to common sources of interference that would generate false positives.

15. The apparatus according to claim 14, wherein to determine whether the calculated velocity of the moving asset is valid, the spoofing and jamming detection module is further configured to compare the calculated velocity with a prescribed reference velocity range, and wherein the spoofing alert is generated when the calculated velocity is determined to be outside of the prescribed reference velocity range.

16. The apparatus according to claim 1, wherein the spoofing and jamming detection module is further configured:
to receive inertial position information relating to the moving asset from a second position data source of the plurality of position data sources;
to synchronize, in time, the GNSS information from the first position data source with the inertial position information from the second position data source;
to interpolate a new data point to match a time of incoming position data relating to the moving asset;
to store a difference between a first position of the moving asset based on the GNSS information and a second position of the moving asset based on the inertial position information;
to determine whether the moving asset is moving; and
to generate a spoofing alert when the moving asset is not subjected to common sources of interference that would generate false positives and the difference between the first and second positions of the moving asset exceeds a prescribed threshold.

17. The apparatus according to claim 1, wherein the spoofing and jamming detection module is further configured:
to obtain reference time information from a reference time source;
to determine a difference between the reference time information and apparatus time information, the apparatus time information based on a system clock of the apparatus;
to generate a timing alert signal when the difference between the reference time information and the apparatus time information exceeds a prescribed threshold and the moving asset is determined to be moving.

18. An apparatus for detecting global navigation satellite system (GNSS) spoofing and jamming in a moving asset, the apparatus comprising:
an intake module, the intake module configured to receive position data relating to the moving asset from a received radio frequency (RF) GNSS signal and to format an analog waveform from the received RF GNSS signal into a corresponding digital signal;
an RF signal processing unit operatively coupled to the intake module, the RF signal processing unit being configured to receive the digital signal provided by the intake module and to extract metadata from the digital signal; and
a spoofing and jamming detection module operatively coupled to the RF signal processing unit,
wherein the metadata extracted by the RF signal processing unit comprises information used to determine a state of a global positioning system (GPS) RF state processing unit in the spoofing and jamming detection module, and
wherein the GPS RF state processing unit is configured to generate an output signal indicative of a presence of a jamming and/or spoofing event, based at least in part on the metadata extracted by the RF signal processing unit.

19. The apparatus according to claim 18, wherein the GPS RF state processing unit is configured to perform one or more tests that indicate a non-normal state of attributes and/or characteristics of the received RF GNSS signal.

20. The apparatus according to claim 18, wherein the RF signal processing unit comprises:
a memory buffer configured to receive and store in-phase and quadrature (I/Q) components received from a complex sample data stream provided by the intake module; and
a plurality of processing pipelines, each of the plurality of processing pipelines being configured to obtain I/Q samples from the memory buffer and to process data in the I/Q samples relating to a corresponding satellite vehicle among a constellation of satellite vehicles.

21. The apparatus according to claim 20, wherein each of the plurality of processing pipelines comprises:
a correlation unit configured to receive the I/Q samples and to correlate GNSS satellite pseudo-random noise (PRN) codes over an entire doppler range to generate doppler correlations for a corresponding satellite vehicle;
a frame combining unit configured to receive correlated samples from the correlation unit and to generate combined GNSS data frames based on the correlated samples;
a peak search unit configured to search through doppler correlations in the combined GNSS data frames for the corresponding satellite vehicle to find two peaks having a largest magnitude and to record metadata associated with the two peaks; and
a carrier-to-noise calculation unit configured to calculate a carrier-to-noise ratio of the doppler correlations for the corresponding satellite vehicle.

22. The apparatus according to claim 21, wherein the correlation unit in each of the plurality of processing pipelines is configured to perform one of frequency domain correlation and time domain correlation.

23. The apparatus according to claim 20, further comprising a fine acquisition peak processing unit configured to detect a peak magnitude of GPS data samples obtained from the complex sample data stream using frequency and time information from a coarse acquisition of the GPS data samples and to process an increased number of GPS data samples at the frequency and time from the coarse acquisition.

24. The apparatus according to claim 18, wherein the intake module comprises a software-defined radio configured to format the analog waveform from the received RF GNSS signal into the corresponding digital signal.

25. The apparatus according to claim 18, wherein the intake module is configured to receive serial position data relating to the moving asset from a plurality of position data sources coupled to a serial data bus and to generate formatted position data based on the received position data, and wherein the spoofing and jamming detection module is configured to generate at least one of a GNSS jamming alert or a GNSS spoofing alert indicative of a presence of a jamming or spoofing event, respectively, based on the formatted position data from the intake module and the output signal generated by the GPS RF state processing unit.
